(19) United States
(12) Patent Application Publication
(10) Pub. No.: US 2026/0116267 A1
(43) Pub. Date: Apr. 30, 2026

(54) UNIVERSAL ADAPTOR PLATE SYSTEM AND METHOD

(71) Applicant: CVG MANAGEMENT CORPORATION, New Albany, OH (US)

(72) Inventor: Davey Joe Jones, Maryville, TN (US)

(21) Appl. No.: 19/313,783

(22) Filed: Aug. 28, 2025

Related U.S. Application Data
(60) Provisional application No. 63/688,008, filed on Aug. 28, 2024.

(51) Int. Cl. B60N 2/015

(52) U.S. Cl. CPC B60N 2/015

(57) ABSTRACT

A universal adaptor plate system is disclosed. The system includes an adapter plate having opposing lateral sides and opposing longitudinal sides defining a generally rectangular structure. A tab is formed along the first longitudinal side, and a recess is defined along the same longitudinal side, the tab being offset from the first lateral side by a distance equal to the offset of the recess from the second lateral side. A tang is formed along the second longitudinal side, and an indent is defined along the same longitudinal side, the tang being offset from the first lateral side by a distance equal to the offset of the indent from the second lateral side. This complementary arrangement enables tessellation of multiple adaptor plates in various configurations, provides structural alignment across joined edges, and facilitates secure mounting of different seat brackets while preserving plate integrity.

### CROSS REFERENCE TO RELATED APPLICATIONS

The application claims priority to and the benefit of U.S. Provisional Patent Application No. 63/688,008, filed on Aug. 28, 2024, entitled “UNIVERSAL ADAPTOR PLATE”, which we incorporate by reference in its entirety.

### BACKGROUND

In the transportation industry, a variety of different vehicles of varying size are in use. The commercial trucking industry, for example, tractor units, i.e., the drive component of a “semi-trailer” or “eighteen wheeler” (in U.S. parlance), or “lorry” in Europe, may be manufactured by a plurality of different companies. Suitable tractor unit manufacturers may include, for example and without limitation PETERBIL T, MACK, KENWORTH, FREIGHTLINER, VOLVO, INTERNATIONAL, GM, FORD, etc. Further, variations on the tractor unit may include, for example and without limitation, long-haul or short-haul configurations, sleeping cabs, etc. Each of these different manufacturers may employ different seats, including mounting brackets, configurations, and the like. Additionally, after-market (i.e., non-original equipment manufacturers (“OEM”)) seats are available for installation in the tractor units. Non-OEM seat manufacturers include, for example and without limitation, NATIONAL SEATING, BOSTROM SEATING, and the like.

Generally, these after-market seats or OEM seats are specific due to the mounting configuration of the tractor unit itself, resulting in drivers being limited to only those seats that are manufactured specifically for a tractor unit manufacturer, often referred to as the “make,” or a particular model of a tractor unit. Currently, a variety of adaptor plate kits are available. Each such kit, however, is specific to not only the seat brand, but often also to the make and/or model of tractor unit or truck. Provided herein is a universal kit or system that replaces each of these kits by allowing for modification of the configuration and mounting points thereof.

### BRIEF SUMMARY

In some embodiments, a system or kit comprises two universal adaptor plates that interlock together in multiple configurations for each specific tractor unit or truck make. Further, the adaptor plates enable attachment of a variety of seats, independent of seat manufacturer. In still other embodiments, validation of the universal kit or system set forth hereinafter has been validated in accordance with FMVSS testing standards.

In one aspect, the disclosure provides a universal adaptor plate system that includes an adapter plate with opposing lateral and longitudinal sides. A tab extends from the first longitudinal side, and a recess is defined along the same side at a complementary location. A tang extends from the second lateral side, and an indent is defined along the same side at a complementary location. The tab and recess are positioned at matched offsets relative to opposite lateral sides, and the tang and indent are positioned at matched offsets relative to opposite longitudinal sides, enabling multiple adaptor plates to interlock in tessellated configurations with aligned edges.

In another aspect, the disclosure provides a universal adaptor plate system configured with a plurality of holes arranged in sets across the longitudinal end portions and middle portion of the adapter plate. The arrangement of these holes accommodates a range of seat brackets having different mounting patterns while maintaining balanced distribution across the plate. The holes are closely spaced to maximize compatibility within a compact footprint but are positioned with sufficient separation to preserve structural integrity and load-bearing strength of the adapter plate.

In another aspect, the disclosure provides a method of manufacturing a universal plate system. The method includes forming an adapter plate with the tab, recess, tang, and indent in matched offset relation as described above. The method further includes forming first through eighth pluralities of holes in prescribed positions on the adapter plate. This manufacturing process produces an adapter plate capable of interlocking with similar plates and receiving fasteners for different seat brackets, thereby standardizing plate geometry while reducing material waste and ensuring compatibility across a wide range of truck and tractor unit seat assemblies.

The innovation disclosed herein introduces systems and methods for implementing a universal adaptor plate system compatible with a wide range of vehicle seat assemblies. In this regard, an adaptor plate is constructed with opposing lateral and longitudinal sides, and incorporates a tab, recess, tang, and indent arranged in matched offset relation. The adaptor plate further defines multiple pluralities of holes distributed across longitudinal end portions and a narrowed middle portion, each positioned to accommodate different seat bracket geometries. By appropriately dimensioning and arranging the tab, recess, tang, indent, and pluralities of holes, the disclosed system enables multiple adaptor plates to interlock in tessellated configurations while maintaining structural stability and alignment. Such systems and methods facilitate standardized installation of diverse seat brackets across different vehicle platforms, allowing reuse of the adaptor plates in varying configurations. Such systems and methods additionally offer improved compatibility, structural integrity, reusability, and cost efficiency relative to conventional vehicle-specific seat mounting plates.

### BRIEF DESCRIPTION OF THE DRAWINGS

FIG. 1 is a first dimensioned top view of an example adapter plate, in accordance with aspects of the innovation.

FIG. 2 is a second dimensioned top view of the adapter plate of FIG. 1.

FIG. 3 is a top view of a universal adaptor plate system including the adapter plate of FIG. 1, in accordance with some embodiments.

FIGS. 4A and 4B are top and isometric views of the universal adaptor plate system in accordance with a first configuration.

FIGS. 5A-5E are illustrative top views of aftermarket and/or OEM seat bases overlaying the universal adaptor plate system of FIGS. 4A and 4B.

FIGS. 6A and 6B are top and isometric views of the universal adaptor plate system in accordance with a second configuration.

FIGS. 7A-7E are illustrative top views of aftermarket and/or OEM seat bases overlaying the universal adaptor plate system of FIGS. 7A and 7B.

FIGS. 8A and 8B are top and isometric views of the universal adaptor plate system in accordance with a first configuration.

FIG. 9A-9E are illustrative top views of aftermarket and/or OEM seat bases overlaying the universal adaptor plate system of FIGS. 8A and 8B.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Numerical values in the specification and claims of this application should be understood to include numerical values which are the same when reduced to the same number of significant figures and numerical values which differ from the stated value by less than the experimental error of conventional measurement technique of the type described in the present application to determine the value. All ranges disclosed herein are inclusive of the recited endpoint.

The term “about” can be used to include any numerical value that can vary without changing the basic function of that value. When used with a range, “about” also discloses the range defined by the absolute values of the two endpoints, e.g., “about 2 to about 4” also discloses the range “from 2 to 4.” For example, the term “about” may refer to plus or minus 10% of the indicated number.

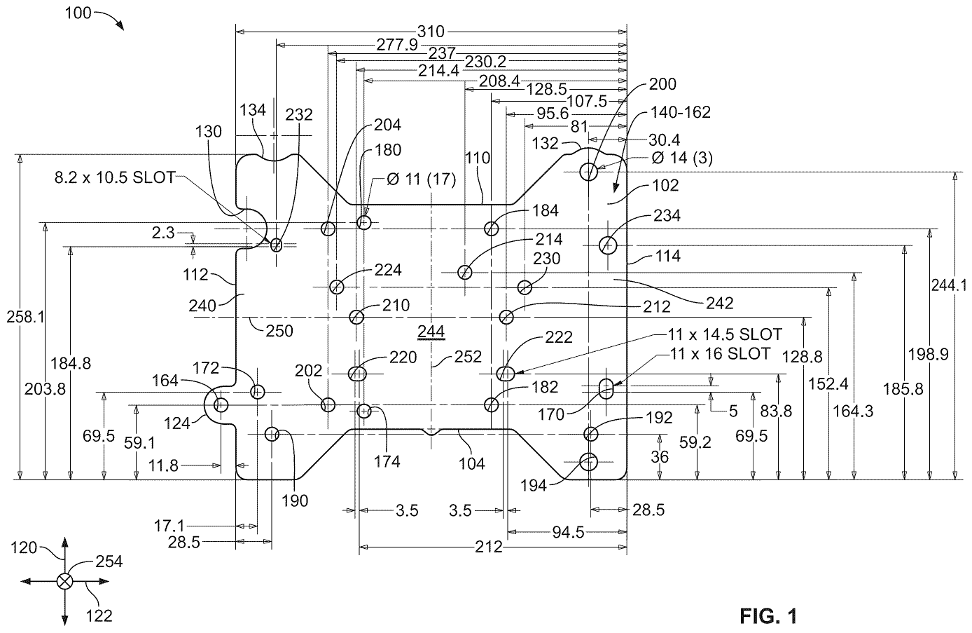

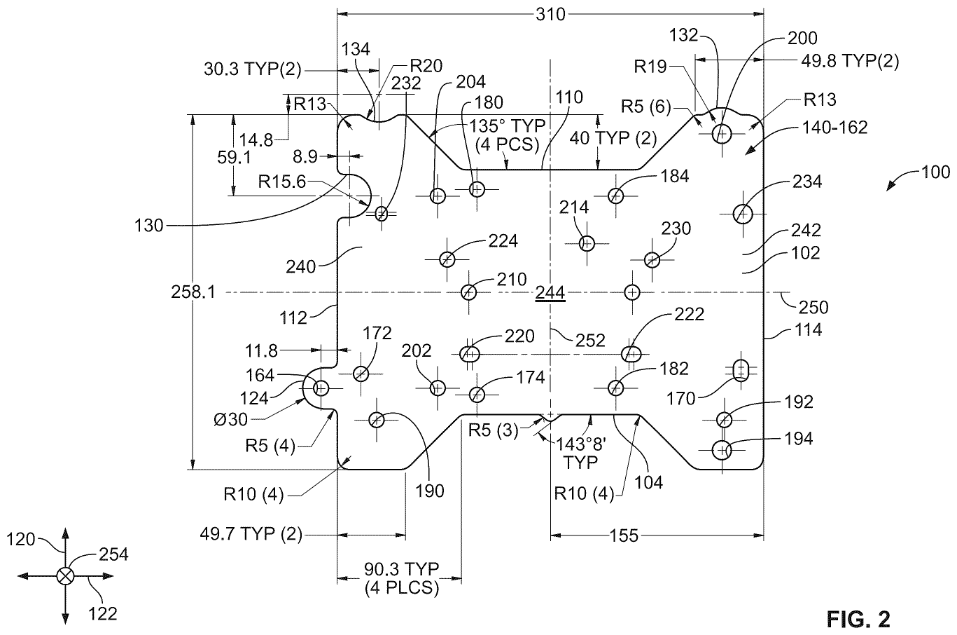

It should, of course, be understood that the description and drawings herein are merely illustrative and that various modifications and changes can be made in the structures disclosed without departing from the present disclosure. Referring now to the drawings, wherein like numerals refer to like parts throughout the several views, FIGS. 1 and 2 illustrate an adapter plate system 100 including a first adapter plate 102 having a first lateral side 104, a second lateral side 110, a first longitudinal side 112, and a second longitudinal side 114. The second lateral side 110 is located opposite the first lateral side 104 in a lateral direction indicated by an arow 120. The second longitudinal side 114 is located opposite the first longitudinal side 112 in a longitudinal direction orthogonal to the lateral direction, indicated by an arrow 122.

The adapter plate system 100 includes a tab 124 extended from the adapter plate 102 in the longitudinal direction at a location along the first longitudinal side 112. The adapter plate 102 defines a recess 130 at a location along the first longitudinal side 112, and the tab 124 is offset from the first lateral side 104 a same distance the recess 130 is offset from the second lateral side 110 in the lateral direction.

The adapter plate system 100 includes a tang 132 extended from the adapter plate 102 in the lateral direction at a location along the second lateral side 110. The adapter plate 102 defines an indent 134 at a location along the second lateral side 114, and the tang 132 is offset from the first longitudinal side 112 a same distance the indent 134 is offset from the second longitudinal side 114. The tang 132 and the indent 134 are disposed a predetermined distance from the sides of the adaptor plate 102 while avoiding the positioning of various mounting holes. For example, in the depicted embodiment, the tang 132 and the indent 134 are centered at 59.1 mm from the first lateral side 104 of the adapter plate 102. The tang 132 and the indent 134 have a radius of 15.6 mm and the tang 132 has a hole centered within the tang 132 and disposed 11.8 mm from the first longitudinal side 112. It will be appreciated that in other embodiments the dimensions and locations of the tang 132 and the indent 134 can be modified or adjusted to fit specific fitments and designs of vehicle hardware.

The tab 124 and the adapter plate 102 define a first plurality of holes 140, a second plurality of holes 142, a third plurality of holes 144, a fourth plurality of holes 150, a fifth plurality of holes 152, a sixth plurality of holes 154, a seventh plurality of holes 160, and an eighth plurality of holes 162. More specifically, in the depicted embodiment, the first plurality of holes 140 includes a first hole 164 centered in the tang 132 and disposed 59.1 mm from the first longitudinal side 112, a 11×16 mm slot hole that is a second hole 170 having a first center 69.5 mm from the first lateral side 104 and a second center 74.5 mm from the first lateral side 104, with both centers 17.1 mm from the second longitudinal side 114, and a third hole 172 centered 69.5 mm from the first lateral side 104 and 17.1 mm from the first longitudinal side 112. The second plurality of holes 142 includes a first hole 174 centered 208.4 mm from the second longitudinal side 114 and 203.8 mm from the second lateral side 110, a second hole 180 centered 208.4 mm from the second longitudinal side 114 and 203.8 mm from the first lateral side 104, a third hole 182 centered 59.2 mm from the first lateral side 104 and 107.5 mm from the second longitudinal side 114, and a fourth hole 184 centered 198.9 mm from the first lateral side 104 and 107.5 mm from the second longitudinal side 114.

The third plurality of holes 144 includes a first hole 190 centered 28.5 mm from the first longitudinal side 112 and 36 mm from the first lateral side 104, a second hole 192 centered 28.5 from the second longitudinal side 114 and 36 mm from the first lateral side 104, a third hole 194 centered 30.4 mm from the second longitudinal side 114 and 14 mm from the first lateral side 104, and a fourth hole 200 centered 30.4 mm from the second longitudinal side 114 and 244.1 mm from the first lateral side 104. The fourth plurality of holes 150 includes a first hole 202 centered 237 mm from the second longitudinal side 114 and 59.1 mm from the first lateral side 104, and a second hole 204 centered 237 from the second longitudinal side 114 and 198.9 mm from the first lateral side 104.

The fifth plurality of holes 152 includes a first hole 210 centered 212 mm from the second longitudinal side 114 and 128.8 mm from the first lateral side 104, a second hole 212 centered 95.6 mm from the second longitudinal side 114 and 128.8 mm from the first lateral side 104, and a third hole 214 centered 128.5 mm from the second longitudinal side 114 and 164.3 mm from the first lateral side 104. The sixth plurality of holes 154 includes a 11×14.5 mm slot hole that is a first hole 220 having a first center 212 mm from the second longitudinal side 114 and a second center 215.5 mm from the second longitudinal side 114, with both centers 83.8 mm from the first lateral side 104, and a 11×14.5 mm slot hole that is a second hole 222 having a first center 94.5 mm from the second longitudinal side 114 and a second center 98 mm from the second longitudinal side 114, with both centers 83.8 mm from the first lateral side 104.

The seventh plurality of holes 160 includes a first hole 224 centered 237 mm from the second longitudinal side 114 and 152.4 mm from the first lateral side 104, and a second hole 230 centered 81 mm from the second longitudinal side 114 and 152.4 mm from the first lateral side 104. The eighth plurality of holes 162 includes a 8.2×10.5 mm slot hole that is a first hole 232 having a first center at 184.8 mm from the first lateral side 104 and a second center at 187.1 from the first lateral side 104, with both centers 277.9 mm from the second longitudinal side 114 and, and a hole 8-2 centered 17.1 mm from the second longitudinal side 114 and 185.8 mm from the first lateral side 104.

It is noted that the holes are designed to have a predetermined manufactured tolerance. For instance, for the above noted dimensions the tolerance is a ±0.8 mm. Furthermore, a length of the adapter plate 102 from the first longitudinal side 112 to the second longitudinal side 114 is 310 mm in the longitudinal direction, and a length of the adapter plate 102 from the first lateral side 104 to the second lateral side 110 is 258.1 mm. As such, where holes in the adapter plate 102 and the tab 124 are described as being a first distance from the first lateral side 104 or the first longitudinal side 112, such holes are also respectively described as being a second distance from the second lateral side 110 or the second longitudinal side 114, the second distance being a remainder of the length of the adapter plate 102 in the lateral direction or the longitudinal direction, after subtracting the first distance.

The adapter plate 102 defines a perimeter boundary in the longitudinal direction that includes a first longitudinal end portion 240, a second longitudinal end portion 242, and a longitudinal middle portion 244 extending between the first longitudinal end portion 240 and the second longitudinal end portion 242. The overall longitudinal length of the adapter plate 102, measured from the first longitudinal side 112 to the second longitudinal side 114, is 310 mm, and the overall lateral width, measured from the first lateral side 104 to the second lateral side 110, is 258.1 mm. In the depicted embodiment, the first longitudinal end portion 240 and the second longitudinal end portion 242 each extend across substantially the full lateral width of 258.1 mm, whereas the longitudinal middle portion 244 is narrowed in the lateral direction relative to the end portions, defining a recessed waist region that reduces material volume while maintaining structural integrity. The narrowing of the longitudinal middle portion 244 is centered on a midpoint of the adapter plate 102 in the longitudinal direction, such that the first longitudinal end portion 240 and the second longitudinal end portion 242 are symmetric with respect to the longitudinal middle portion 244.

With this construction, the first plurality of holes 140 includes the first hole 164 in the tab 124 and the second hole 170 in the adapter plate 102. The first hole 164 of the first plurality of holes 140 is located beyond the first longitudinal side 112 in the longitudinal direction. In embodiments, the second hole 170 in the first plurality of holes 140 shares a common position with the first hole 164 in the lateral direction, such that the second hole 170 overlaps the first hole 164 in the longitudinal direction. The second hole 170 in the first plurality of holes 140 may additionally or alternatively be located inward of the first hole 164. The second hole 170 is located closer to the second longitudinal side 114 as compared to the first longitudinal side 112 in the longitudinal direction. The third hole 172 in the first plurality of holes 140 is aligned with the second hole 170 in the longitudinal direction, and located closer to the first longitudinal side as compared to the second longitudinal side.

The second plurality of holes 142 includes the first hole 174 and the second hole 180, which are each located closer to the first longitudinal side 112 as compared to the second longitudinal side 114. The second plurality of holes 142 also includes the third hole 182 and the fourth hole 184 located closer to the second longitudinal side 114 as compared to the first longitudinal side 112. The first hole 174 and the third hole 182 are located closer to the first lateral side 104 as compared to the second lateral side 110, and the second hole 180 and the fourth hole 184 are located closer to the second lateral side 110 as compared to the first lateral side 104.

The first hole 174 and the second hole 180 in the second plurality of holes 142 are offset from the first longitudinal side 112 in the longitudinal direction, and the third hole 182 and the fourth hole 184 in the second plurality of holes 142 are offset from the second longitudinal side 114 a same distance as the first hole 174 and the second hole 180 from the first longitudinal side 112. The first hole 174 and the third hole 182 in the second plurality of holes 174 are offset from the first lateral side 104, and the second hole 180 and the fourth hole 184 in the second plurality of holes 142 are offset from the second lateral side 110 a same distance as the first hole 174 and the third hole 182 from the first lateral side 104.

The adapter plate 102 includes the first longitudinal end portion 240, the second longitudinal end portion 242, and the longitudinal middle portion 244 that is narrower in the lateral direction than the first longitudinal end portion 240 and the second longitudinal end portion 242. The longitudinal middle portion 244 is interposed between and separates the first longitudinal end portion 240 and the second longitudinal end portion 242, and extends across a midpoint of the adapter plate 102 in the longitudinal direction.

As shown in FIG. 1, the first longitudinal end portion 240 supports the tab 124 and defines the recess 130. The tab defines the first hole 164 in the first plurality of holes 140. The first longitudinal end portion 240 also defines the first hole of the first plurality of holes 140, the third hole of the first plurality of holes 140, the first hole of the third plurality of holes 144, the first hole of the fourth plurality of holes 150, the second hole of the fourth plurality of holes 150, the first hole of the seventh plurality of holes 160, and the first hole of the eighth plurality of holes 162.

The longitudinal middle portion 244 defines the second plurality of holes 142, the fifth plurality of holes 152, and the sixth plurality of holes 154. The second longitudinal end portion 242 supports the tang 132, and defines the indent 134. The second longitudinal end portion 242 also defines the second hole of the first plurality of holes 140, the second hole of the third plurality of holes 144, the third hole of the third plurality of holes 144, the fourth hole of the third plurality of holes 144, the second hole of the sixth plurality of holes 154, the second hole of the seventh plurality of holes 160, and the second hole of the eighth plurality of holes 162.

With this construction, the pluralities of holes 140-162 are distributed across the respective first longitudinal end portion 240, the longitudinal middle portion 244, and the second longitudinal end portion 244 of the adapter plate 102 in a manner that provides spatially balanced seat bracket mounting options and structural continuity along the perimeter boundary, and structural stability through the adapter plate 102.

The overall length and width of the adapter plate 102 in the longitudinal direction and the lateral direction accommodates the arrangement of the holes 164-234. In this regard, embodiments of the adapter plate 102 include the first longitudinal end portion with a minimum length of 90 mm and a minimum width of 180 mm. Embodiments of the adapter plate 102 include the second longitudinal end portion 242 with a minimum length of 90 mm, and a minimum width 245 mm. As depicted, the longitudinal middle portion 244 narrows 80 mm in the lateral direction from the first longitudinal end portion 240 and the second longitudinal end portion 242. In this regard, each of the first lateral side 104 and the second lateral side 110 recess inward in the lateral direction 40 mm between the first longitudinal side 112 and the second longitudinal side 114, defining the narrowed structure of the longitudinal middle portion 244. In embodiments, the longitudinal middle portion 244 has a minimum width of 150 mm, and a minimum length of 100 mm. The narrowed construction of the longitudinal middle portion 244 reduces overall material usage in manufacturing the adapter plate 102, decreases weight of the adapter plate 102, and creates recessed lateral regions in the adapter plate 102 that correspond to apertures formed when the adapter plate 102 is combined in the adaptor plate system 100 configurations described in detail below. With this construction, the third plurality of holes 144 are each located in the first longitudinal end portion 240 or the second longitudinal end portion 242, closer to the first lateral side 104 as compared to the second lateral side 110, and are each located beyond the first lateral side 104 at the middle longitudinal portion 244 in the lateral direction.

The third plurality of holes 144 includes a third hole 194 and a fourth hole 200 defined in the second longitudinal end portion 242, aligned with each other in the lateral direction, and overlapping the second hole 192 of the third plurality of holes 144 in the lateral direction. The third hole 194 in the third plurality of holes 144 is located closer to the first lateral side 104 as compared to the second lateral side 110, and the fourth hole 200 in the third plurality of holes 144 is located closer to the second lateral side 110 as compared to the first lateral side 104.

The adapter plate 102 defines a fourth plurality of holes 150 that are each offset from the second plurality of holes 142 in the longitudinal direction, defined in the first longitudinal end portion 240, and located closer to the first longitudinal side 112 as compared to the second longitudinal side 114. The fourth plurality of holes 150 includes the first hole 202 that overlaps the first hole 174 and the third hole 182 in the second plurality of holes 144. The fourth plurality of holes 150 includes the second hole 204 that overlaps the second hole 180 and the fourth hole 184 in the second plurality of holes 142.

The fifth plurality of holes 152 are aligned in the longitudinal direction, on a longitudinal middle line 250 of the adapter plate 102. The adapter plate 102 defines the sixth plurality of holes 154 aligned in the longitudinal direction, offset from the fifth plurality of holes 152 in the lateral direction, and located closer to the first lateral side 104 as compared to the second lateral side 110 in the lateral direction. The fifth plurality of holes 152 includes the third hole 214 positioned between the first hole 210 and the second hole 212 in the longitudinal direction, and located closer to the second lateral side 110 as compared to the first lateral side 104 in the lateral direction.

The seventh plurality of holes 160 is aligned in the longitudinal direction and is offset from the fifth plurality of holes 152 in the lateral direction. The seventh plurality of holes 160 is located closer to the second lateral side 110 as compared to the first lateral side 104, and is located outward of the second plurality of holes 142 in the longitudinal direction.

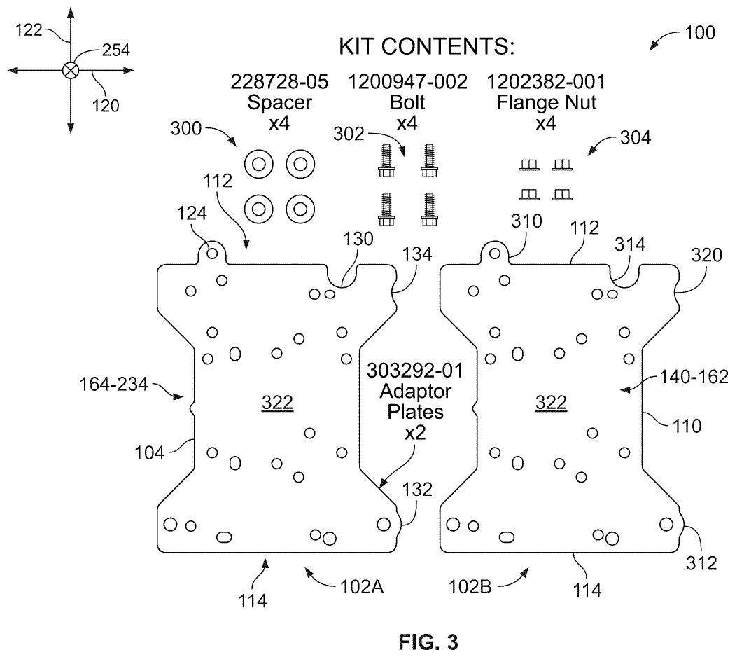

The eighth plurality of holes 162 is aligned in the longitudinal direction and is offset from the fifth plurality of holes 152 in the lateral direction farther than the seventh plurality of holes 160. The eighth plurality of holes 162 is located closer to the second lateral side 110 as compared to the first lateral side 104, and is located outward of the seventh plurality of holes 160 in the longitudinal direction and the lateral direction. While in the depicted embodiment the eighth plurality of holes 162 includes two holes, the eighth plurality of holes 162 may include four holes arranged outward of the third plurality of holes 144 in both the lateral direction and the longitudinal direction, as shown in FIG. 3. With continued reference to FIGS. 1 and 2, the fifth plurality of holes 152, the sixth plurality of holes 154, the seventh plurality of holes 160, and the eighth plurality of holes 162 are respectively symmetric in the longitudinal direction and centered on a lateral middle line 252 of the adapter plate 102.

The adapter plate 102 is planar in a normal direction perpendicular to the longitudinal direction and the lateral direction, indicated by an arrow 254. With this construction, the adapter plate 102 may fit with similar adapter plates in various planar configurations as described in detail below, where the adapter plate 102 is a first adapter plate, the tab is a first tab, the recess is a second recess, the tang is a first tang, the indent is a first indent, and the adapter plate system 100 further includes a second adapter plate that is the same or similar as the adapter plate 102, and also having a second tab and a second tang.

With the described arrangement of the holes 164-234 defined relative to each other and the sides and portions of the adapter plate 102, the adaptor plate system 100 may fix with and support various different seat brackets mounted thereon. The distribution of the pluralities of holes 140-162 allows multiple seat bracket geometries to be accommodated without requiring additional adaptors, modifications, or an expanded footprint of the adapter plate 102. The holes 164-234 are positioned in close proximity so that bracket fasteners may be received within a compact footprint, thereby enabling efficient use of surface area and constituent material of the adapter plate 102. At the same time, the described spacing between adjacent holes 164-234 is sufficient to preserve the structural integrity of the constituent material forming the adapter plate 102, avoiding excessive weakening in the adapter plate 102 that could otherwise result from clustering of the holes 164-234. As such, the described arrangement of the holes 164-234 provides a balance between maximum compatibility with different seat patterns in limited footprint, and retention of load-bearing strength, ensuring that the adaptor plate system 100 including the adapter plate 102 can reliably sustain installation stresses and operational forces in service.

Turning now to FIG. 3, there is shown an exploded view of the adaptor plate system 100 in accordance with some embodiments. As shown in FIG. 1, the adaptor plate system 100 includes one or more universal adaptor plates, e.g., a first universal adaptor plate 102A, a second universal adaptor plate 102B, etc., one or more spacer components 300, one or more connector or threaded components 302 (e.g., bolts, screws, etc.) and one or more connector or threaded engagement components 304 (e.g., nuts, etc.). The first universal adapter plate 102A and the second universal adapter plate 102B each include a same construction as described with respect to the adapter plate 102 of FIGS. 1 and 2, including the overall dimensioning of the adapter plate 102 at the first longitudinal end portion 240, the second longitudinal end portion 242, and the longitudinal middle portion 244, and including the arrangement of the holes 164-234.

It will be appreciated that the number of spacer components 300, threaded components 302, and threaded engagement components 304 may vary in accordance with the make and/or model of tractor unit into which the adaptor plate system 100 is installed, and the illustration of FIG. 3 is intended solely as one non-limiting example thereof.

As shown in FIG. 3, the adaptor plate system 100 includes one or more universal adaptor plates 102A-102B, which are implemented in a substantially planar configuration. According to some embodiments, the universal adaptor plate 102A-102B may be constructed of a suitable material, e.g., metal, metal-alloy, or the like. In such embodiments, the universal adaptor plate 102A-102B may be fabricated from sheet metal via stamping processes, lathing processes, cutting processes, or the like. Further, it will be appreciated that the universal adaptor plate 102A-102B may be implemented with a range of thicknesses suitable for the disclosed applications.

In accordance with some embodiments, each universal adaptor plate 102A or 102B is configured to engage another such adaptor plate 102A or 102B, respectively, (as discussed in greater detail below). In this regard, the first adapter plate 102A is fixed with the first tab 124 and the first tang 132, the second adapter plate 102B is fixed with a second tab 310 and a second tang 312. The first adapter plate 102A, the first tab 124, and the first tang 132 include similar features and function in a similar manner as the second adapter plate 102B, the second tab 310, and the second tang 312. More specifically, the second tab 310 extends from the second adapter plate 102B at a location along the first longitudinal side 112 of the second adapter plate 102B. The second adapter plate 102B defines a second recess 314 at a location along the first longitudinal side 112, and the second tab 310 is offset from the first lateral side 104 a same distance that the second recess 314 is offset from the second lateral side 110 in the lateral direction. The second tang 312 extends from the second adapter plate 102B at a location along the second lateral side 110, and the second adapter plate 102B defines a second indent 320 at a location along the second lateral side 110. The second tang 312 is offset from the first longitudinal side 112 a same distance that the second indent 320 is offset from the second longitudinal side 114 in the longitudinal direction. With this construction, the second adapter plate 102B mirrors the first adapter plate 102A in perimeter geometry and hole arrangement, thereby allowing the two plates to be interchangeably positioned and engaged in multiple system configurations.

In the orientation shown in FIG. 3, the top surface 322 of the adaptor plates 102A and 102B are shown. Each adaptor plate 102A-102B includes the first longitudinal side 112, the second longitudinal side 114, the second lateral side 110 and the first lateral side 104. It should be appreciated by the skilled artisan that the designations of the sides 114-120 are intended solely to assist in describing the embodiments set forth herein, and the use of top, bottom, left, and right are only used to assist in viewing FIG. 3 and are not intended to limit the subject disclosure. It will be understood that the adaptor plates 102A and 102B each includes a bottom surface 324.

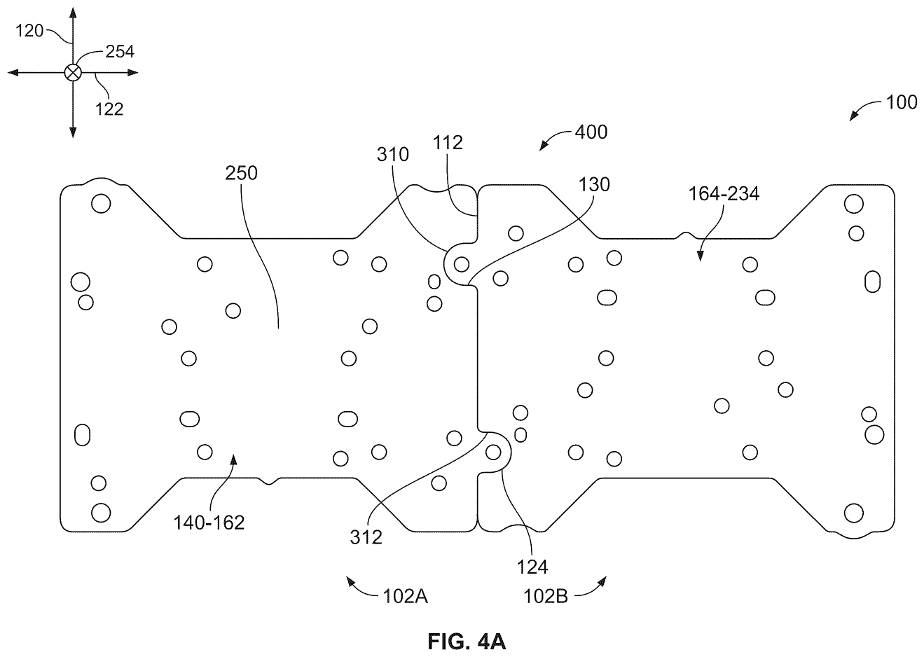

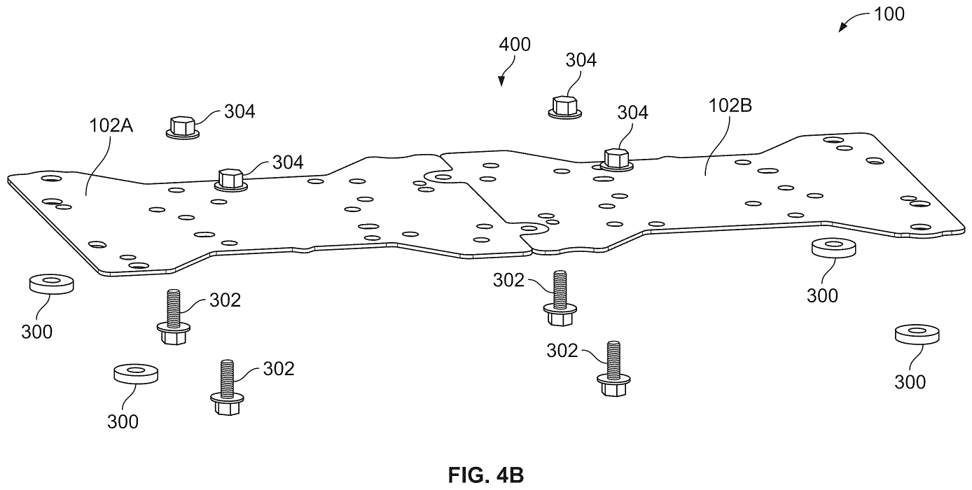

As illustrated in FIG. 3, the universal adaptor plates 102A and 102B include the pluralities of holes 140-162 extending from the top surface 322 of the plate 102A-102B through to the bottom surface 324 thereof. When viewed from the top, as shown in FIG. 3, the adaptor plates 102A-102B each include the first tab 124 or the second tab 310 extending outward from the first longitudinal side 112, and the first recess 130 extending inward from the first longitudinal side 112. It will be appreciated that the first recess 130 of the first adaptor plate 102A is suitably configured to engage the second tab 310 extending from the second adaptor plate 102B, as discussed in greater detail below with respect to FIGS. 4A-4B. It will be appreciated that the location, spacing, and size of the holes 164-234 enable a variety of aftermarket and/or OEM seats to attach thereto, as well as providing the ability to attach with a variety of tractor unit makes and models.

Continuing with FIG. 3, the universal adaptor plates 102A-102B respectively further include the first indent 134 and the second indent 320 positioned on the second lateral side 110 proximal to the first longitudinal side 112. The corresponding first tang 132 and second tang 312 are respectively positioned on the second lateral side 110 proximal to the second longitudinal side 114, respectively configured to engage the corresponding first indent 134 or the corresponding second indent 320 of an adjacent adaptor plate 102A or 102B, as illustrated and discussed below with respect to FIGS. 4A-4B.

Turning now to FIGS. 4A and 4B, there are shown respective top and isometric views of a first configuration 400 of the adaptor plate system 100. As shown in FIGS. 4A and 4B, two adaptor plates 102A and 102B are engaged on a substantially level plane. In the first configuration 400, it will be appreciated that the first tab 124 of a first adaptor plate 102A slidably engages the second recess 314 of a second adaptor plate 102B. As shown in FIGS. 4A and 4B, the top surfaces 322 of each adaptor plate 102A and 102B adjoin, forming a continuous adaptor plate system with each second longitudinal side 114 on opposing ends thereof.

In the depicted embodiment, the first tab 124 and the second recess 314 are positioned along the first longitudinal side 112 of the respective adaptor plates 102A and 102B such that lateral spacing is complementary for tessellating the adapter plates 102A and 102B along the first longitudinal side 112. More specifically, the first recess 130 and the second recess 314 are spaced inward from the second lateral side 110 by a first lateral distance, and the first tab 124 and the second tab 310 are spaced inward from the first lateral side 104 by a second lateral distance, where the first lateral distance matches the second lateral distance. With this construction, when the first adaptor plate 102A and the second adaptor plate 102B are positioned adjacent to each other, the first tab 124 slidably engages within the second recess 314 while the opposite lateral sides of the adapter plates 102A and 102B are aligned. In this manner, the first lateral sides 104 and the second lateral sides 110 of the adaptor plates 102A and 102B remain co-linear, and the adjoining longitudinal edges of the plates tessellate to form a continuous perimeter boundary. This tessellation enables the adaptor plates 102A and 102B to interlock in the first configuration 400 while maintaining both dimensional alignment and structural continuity along a joined edge at the first longitudinal sides 112 of the adaptor plates 102A and 102B.

In the configuration 400 of FIGS. 4A and 4B, the second longitudinal side 114 of the first adaptor plate 102A is positioned towards the front of the cab of the tractor unit, and the second lateral side 114 of the second adaptor plate 102B is positioned opposite thereof, towards the rear of the cab of the tractor unit. Attachment points of the adaptor plate configuration 400 of FIGS. 4A and 4B are highlighted, indicating the appropriate mounting points (e.g., holes 164-234) to be used to secure the configuration 400 to the floor of the cab (not shown). It will be appreciated that the first configuration 400 of FIGS. 2A and 2B corresponds to various models produced by, for example and without limitation, PETERBILT and KENWORTH, including, e.g., models 579, 589, T680, T880, and the like.

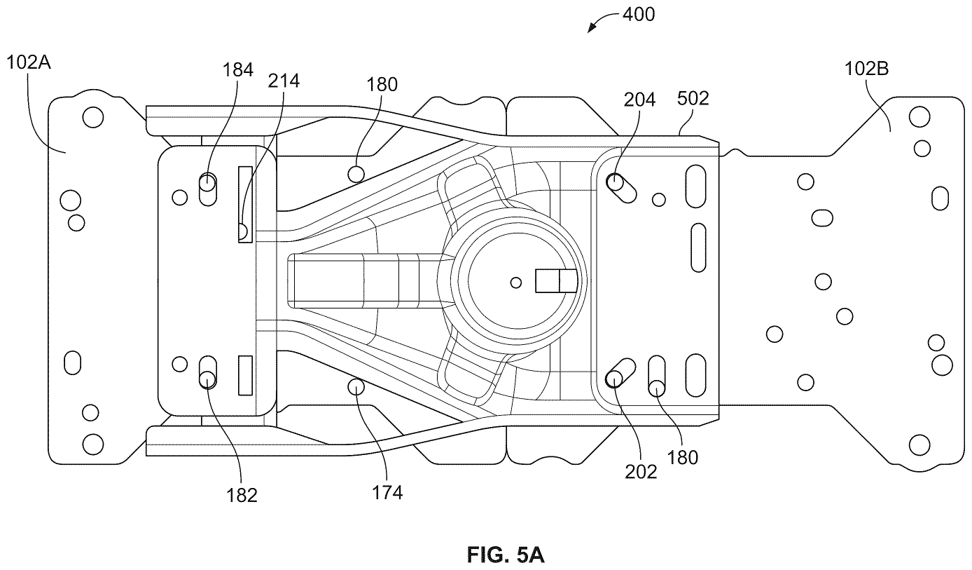

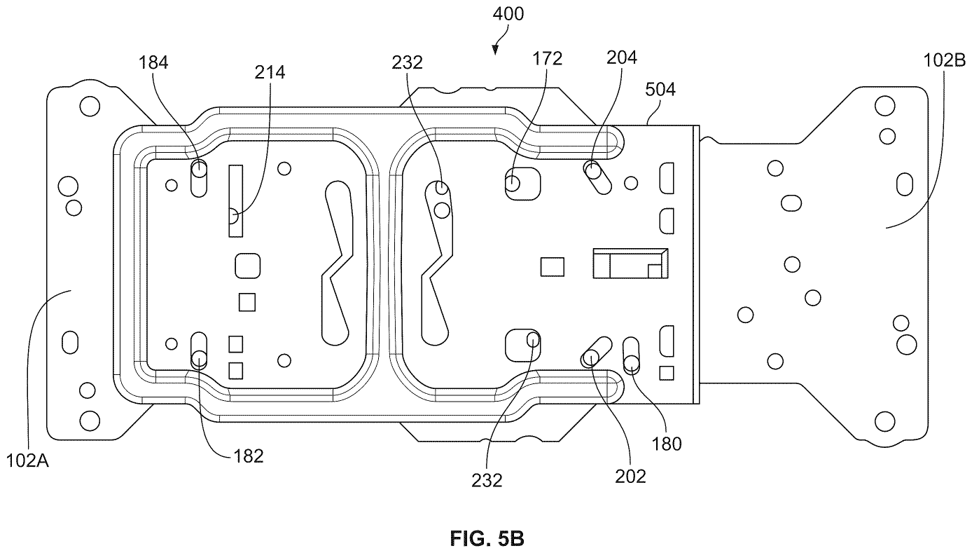

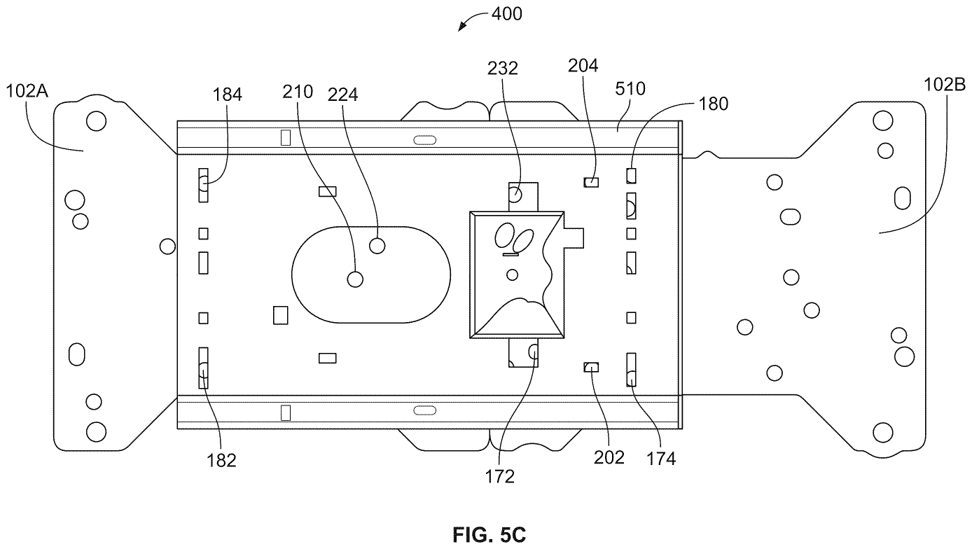

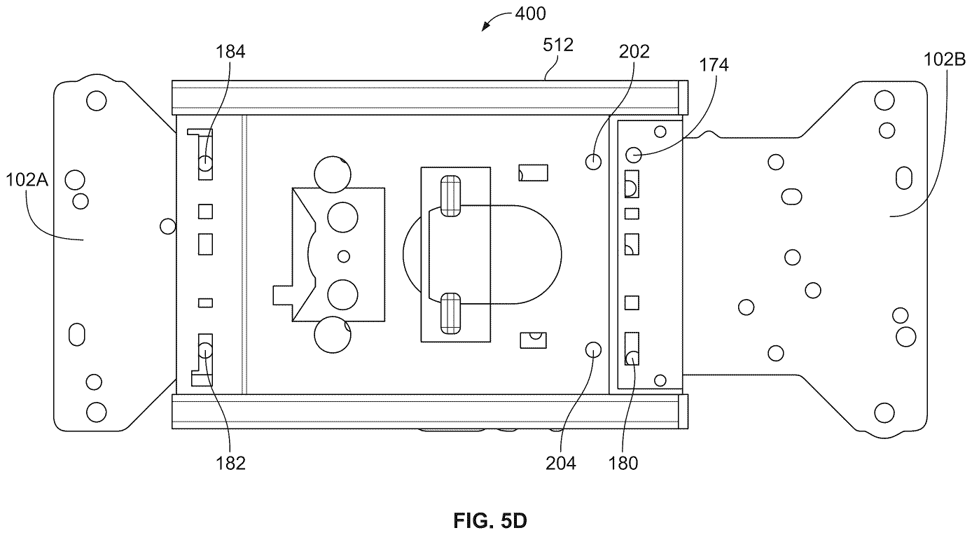

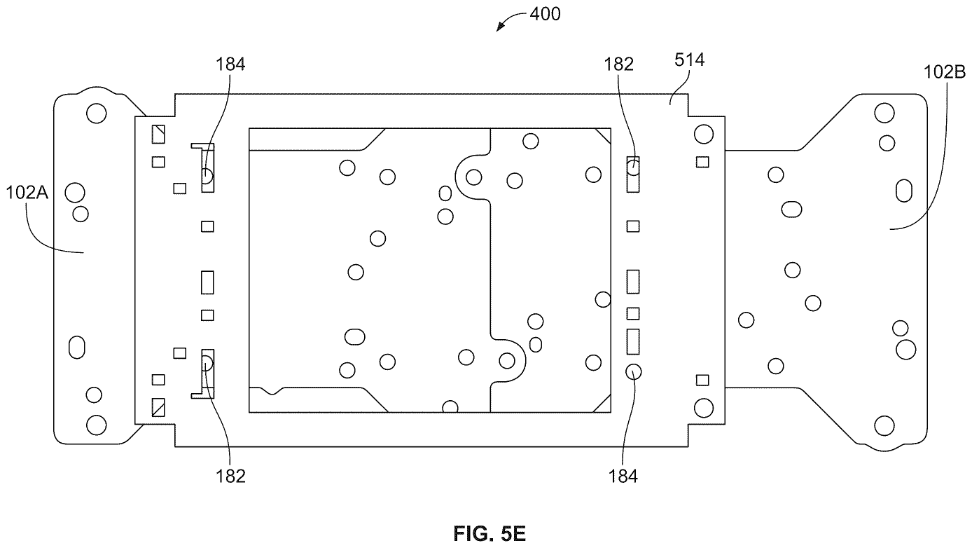

FIGS. 5A-5E provide illustrations of seat brackets 502-514 that may be secured to the adaptor plate configuration 400 of FIGS. 4A and 4B. Thus, FIG. 5A provides an illustration of a first seat bracket 502 for attachment to the adaptor plate configuration 400 of FIGS. 4A and 4B. In FIG. 5A, the first seat bracket 502 corresponds to aftermarket and/or OEM seats of a first type. Examples of such first type of seat include, without limitation, NATIONAL branded COMMODORE and ADMIRAL type seats. FIG. 5A further highlights those of the holes 164-234 configured to receive mounting points of the first seat bracket 502 for securing the first seat bracket 502 and seat (not shown) to the adaptor plate configuration 400. In this regard, each of the first hole 174, the second hole 180, the third hole 182, and the fourth hole 184 of the second plurality of holes 142, and the first hole 202 and the second hole 204 of the fourth plurality of holes 150 correspond to slots or adjacent surfaces defined in the first seat bracket 502 as optional fixation points between the adaptor plates 102A and 102B and the first seat bracket 502.

Referring now to FIG. 5B, there is shown an illustration of a second seat bracket 504 for attachment to the adaptor plate configuration 400 of FIGS. 4A and 4B. In FIG. 5B, the second seat bracket 504 corresponds to aftermarket and/or OEM seats of a second type. Examples of such second type of seat include, without limitation, NATIONAL branded ENSIGN, CAPTAIN, and CORSAIR type seats. FIG. 5B further highlights those of the holes 164-234 are configured to receive mounting points of the second seat bracket 504 for securing the second seat bracket 504 and seat (not shown) to the first adaptor plate configuration 400. In this regard, each of the third hole 172 of the first plurality of holes 140, the second hole 180, the third hole 182, and the fourth hole 184 of the second plurality of holes 142, the first hole 202 and the second hole 204 of the fourth plurality of holes 150, the third hole 214 of the fifth plurality of holes 152, and the first hole 232 of the eighth plurality of holes 162 correspond to slots or adjacent surfaces defined in the second seat bracket 504 as optional fixation points between the adaptor plates 102A and 102B and the second seat bracket 504.

FIG. 5C provides an illustration of a third seat bracket 510 for attachment to the adaptor plate configuration 400 of FIGS. 4A and 4B. In FIG. 5C, the third seat bracket 510 corresponds to aftermarket and/or OEM seats of a third type. Examples of such third type of seat include, without limitation, BOSTROM branded T-SERIES type seats. FIG. 5C further highlights those of the holes 164-234 configured to receive mounting points of the seat bracket 510 for securing the seat bracket 510 and seat (not shown) to the adaptor plate configuration 400. In this regard, each of the third hole 172 of the first plurality of holes 140, the first hole 174, the second hole 180, the third hole 182, and the fourth hole 184 of the second plurality of holes 142, the first hole 202 and the second hole 204 of the fourth plurality of holes 150, the first hole 210 of the fifth plurality of holes 152, the first hole 224 of the seventh plurality of holes 160, and the first hole 232 of the eighth plurality of holes 162 correspond to slots or adjacent surfaces defined in the third seat bracket 510 as optional fixation points between the adaptor plates 102A and 102B and the third seat bracket 510.

FIG. 5D provides an illustration of a fourth seat bracket 512 for attachment to the adaptor plate configuration 400 of FIGS. 4A and 4B. In FIG. 5D, the fourth seat bracket 512 corresponds to aftermarket and/or OEM seats of a fourth type. Examples of such fourth type of seat include, without limitation, BOSTROM branded PRO-RIDE type seats. FIG. 5D further highlights those of the holes 164-234 configured to receive mounting points of the third seat bracket 512 for securing the third seat bracket 512 and seat (not shown) to the adaptor plate configuration 400. In this regard, each of the first hole 174, the second hole 180, the third hole 182, and the fourth hole 184 of the second plurality of holes 142, and the first hole 202 and the second hole 204 of the fourth plurality of holes 150 correspond to slots or adjacent surfaces defined in the fourth seat bracket 512 as optional fixation points between the adaptor plates 102A and 102B and the fourth seat bracket 512.

FIG. 5E provides an illustration of a fifth seat bracket 514 for attachment to the adaptor plate configuration 400 of FIGS. 4A and 4B. In FIG. 5E, the fifth seat bracket 514 corresponds to aftermarket and/or OEM seats of a fifth type. Examples of such fifth type of seat include, without limitation, BOSTROM branded WIDE-RIDE type seats. FIG. 5E further highlights those of the holes 164-234 configured to receive mounting points of the fifth seat bracket 514 for securing the fifth seat bracket 514 and seat (not shown) to the first adaptor plate configuration 400. In this regard, each of the third hole 182 and the fourth hole 184 of the second plurality of holes 142 correspond to slots or adjacent surfaces defined in the fifth seat bracket 514 as optional fixation points between the adaptor plates 102A and 102B and the fifth seat bracket 514.

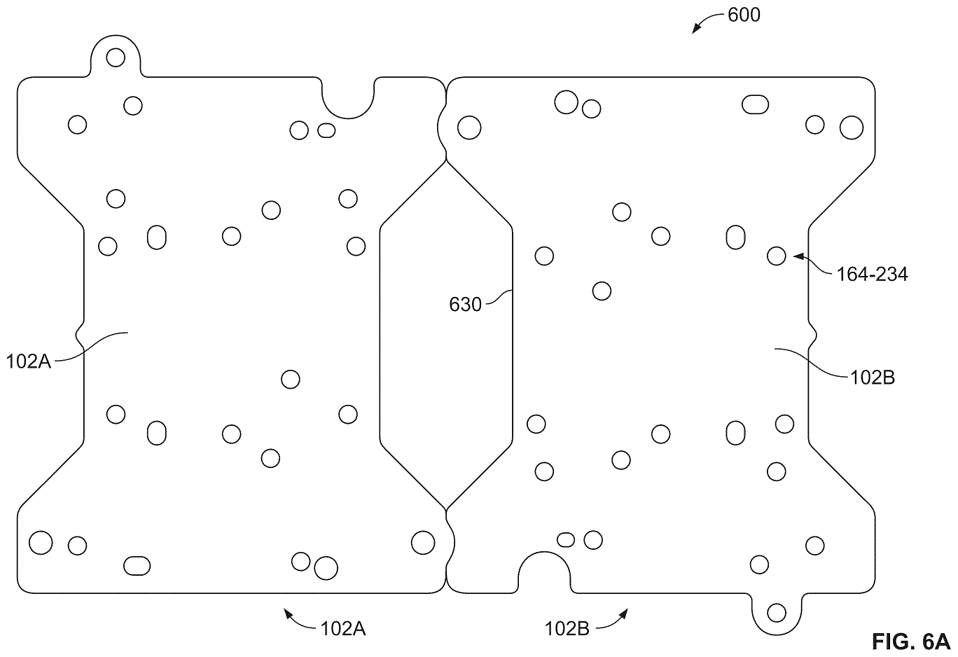

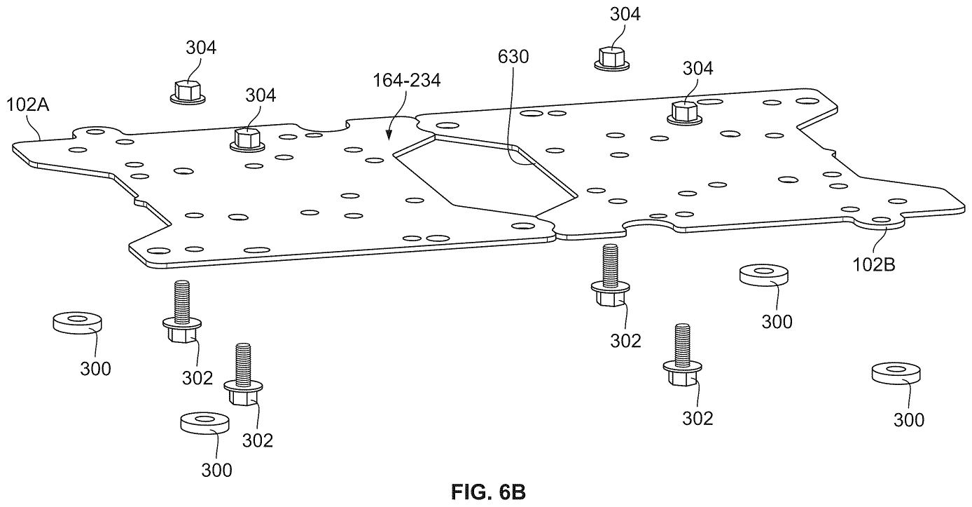

Turning now to FIGS. 6A and 6B, there are shown respective top and isometric views of a second configuration 600 of the adaptor plate system 100. As shown in FIGS. 6A-6B, two adaptor plates 102A and 102B are engaged on a substantially level plane. In the second configuration 600, it will be appreciated that the first tang 132 of the first adaptor plate 102A slideably engages the second indent 320 of the second adaptor plate 102B. As shown in FIGS. 6A-6B, the second lateral sides 114 of each adaptor plate 102A and 102B adjoin, forming a continuous adaptor plate system 600 with the first longitudinal side 112 of the first adaptor plate 102A co-linear with the second longitudinal side 114 of the second adaptor plate 102B, and vice versa. In this arrangement, the second lateral side 110 of the first adaptor plate 102A and the second lateral side 110 of the second adaptor plate 102B together define a first aperture 630. The first tab 124 of the first adaptor plate 102A engages within the second indent 320 of the second adaptor plate 102B, and the second tab 310 of the second adaptor plate 102B engages within the first indent 134 of the first adaptor plate 102A at a location along an opposite side of the first aperture 630 in the longitudinal direction. With this construction, the adaptor plates 102A and 102B interlock in the second configuration 600 to form a tessellated structure that preserves alignment, defines the first aperture 630 for use in system-level mounting, and maintains structural continuity across the joined second lateral sides 110.

In the configuration 600 of FIGS. 6A-6B, the first lateral side 104 of the first adaptor plate 102A is positioned towards the front of the cab of the tractor unit, and the second lateral side 110 of the second adaptor plate 102B is positioned opposite thereof, towards the rear of the cab of the tractor unit. Attachment points of the adaptor plate configuration 600 of FIGS. 6A-6B are highlighted, indicating the appropriate mounting points of the holes 164-234 to be used to secure the configuration 600 to the floor of the cab (not shown). It will be appreciated that the configuration 600 of FIGS. 6A-6B corresponds to various models produced by, for example and without limitation, VOLVO, including, e.g., models in the VNR (regional haul trucks) family, VNL (long haul trucks) family, and the like.

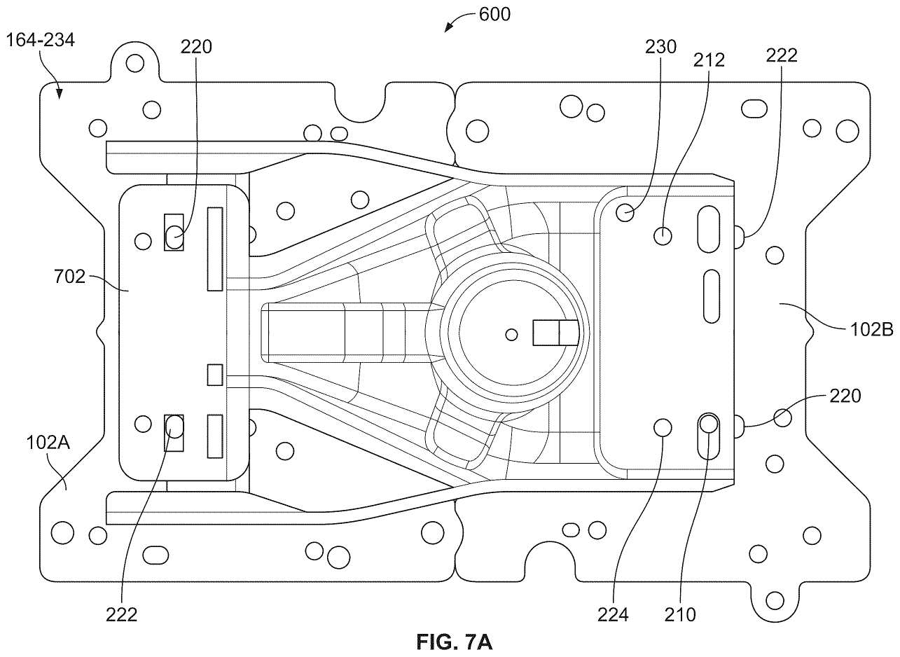

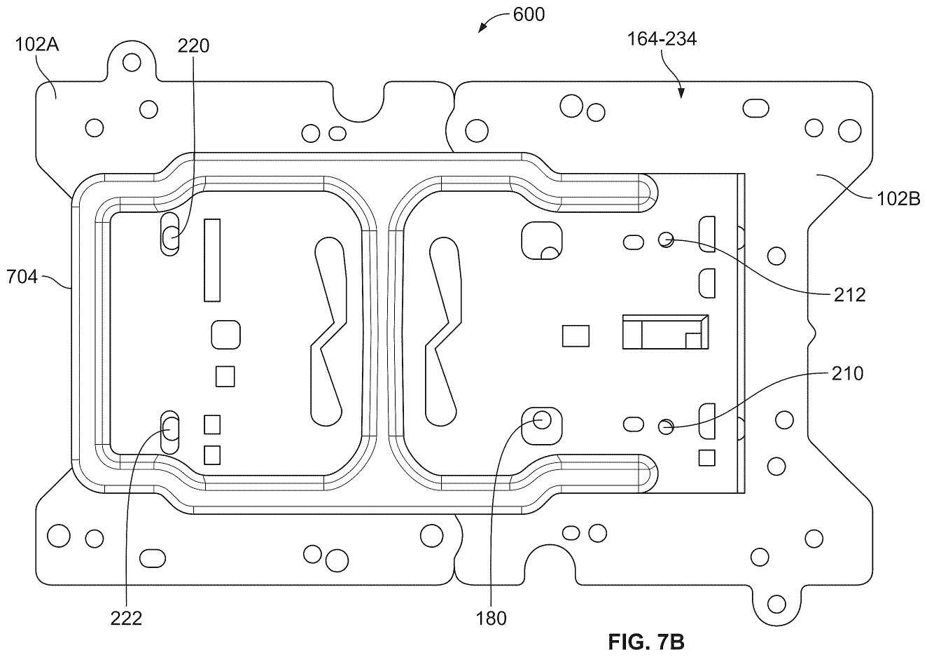

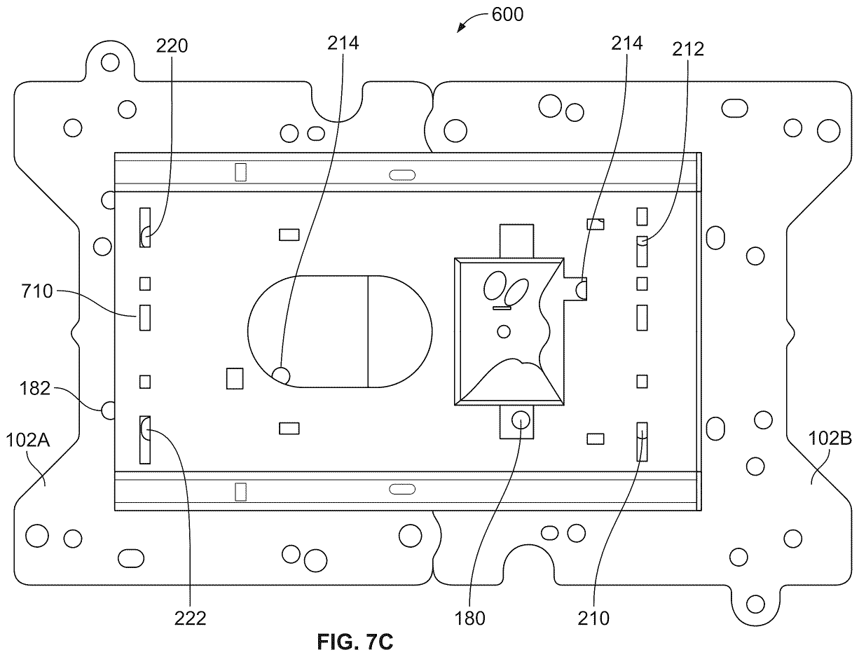

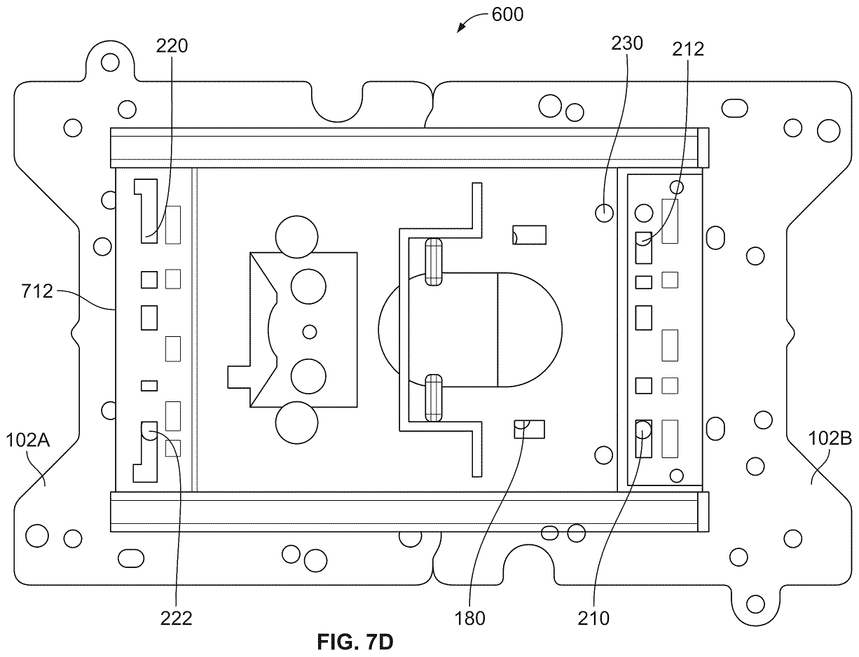

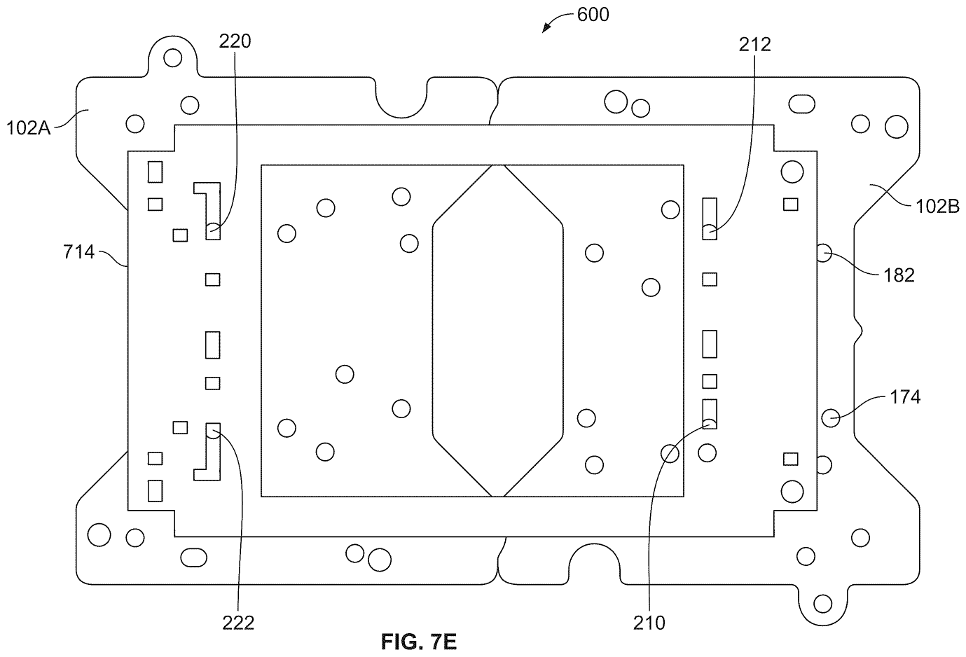

FIGS. 7A-7E provide illustrations of seat brackets 702-714 that may be secured to the second adaptor plate configuration 600 of FIGS. 6A-6B. Thus, FIG. 7A provides an illustration of the first seat bracket 702 for attachment to the second adaptor plate configuration 600 of FIGS. 6A-6B. In FIG. 7A, the first seat bracket 702 corresponds to aftermarket and/or OEM seats of a first type. Examples of such first type of seat include, without limitation, NATIONAL branded COMMODORE and ADMIRAL type seats. FIG. 7A further highlights those of the holes 164-234 configured to receive mounting points of the first seat bracket 702 for securing the first seat bracket 702 and seat (not shown) to the second adaptor plate configuration 600. In this regard, each of the first hole 210 and the second hole 212 of the fifth plurality of holes 152, the first hole 220 and the second hole 222 of the sixth plurality of holes 154, and the first hole 224 and the second hole 230 of the seventh plurality of holes 160 correspond to slots or adjacent surfaces defined in the first seat bracket 702 as optional fixation points between the adaptor plates 102A and 102B and the first seat bracket 702.

Referring now to FIG. 7B, there is shown an illustration of the second seat bracket 704 for attachment to the second adaptor plate configuration 600 of FIGS. 6A-6B. In FIG. 7B, the second seat bracket 704 corresponds to aftermarket and/or OEM seats of a second type. Examples of such second type of seat include, without limitation, NATIONAL branded ENSIGN, CAPTAIN, and CORSAIR type seats. FIG. 5B further highlights those of the holes 164-234 configured to receive mounting points of the second seat bracket 704 for securing the second seat bracket 704 and seat (not shown) to the second adaptor plate configuration 600. In this regard, each of the second hole 180 of the second plurality of holes 142, the first hole 210 and the second hole 212 of the fifth plurality of holes 152, and the first hole 220 and the second hole 222 of the sixth plurality of holes 154 correspond to slots or adjacent surfaces defined in the first seat bracket 702 as optional fixation points between the adaptor plates 102A and 102B and the first seat bracket 702.

FIG. 7C provides an illustration of the third seat bracket 510 for attachment to the second adaptor plate configuration 600 of FIGS. 6A-7B. In FIG. 7C, the third seat bracket 510 corresponds to aftermarket and/or OEM seats of a third type. Examples of such third type of seat include, without limitation, BOSTROM branded T-SERIES type seats. FIG. 5C further highlights those of the holes 164-234 configured to receive mounting points of the third seat bracket 510 for securing the third seat bracket 510 and seat (not shown) to the second adaptor plate configuration 600. In this regard, each of the second hole 180 and the third hole 182 of the second plurality of holes 142, the first hole 210 and the second hole 212 of the fifth plurality of holes 152, the third hole 214 of the fifth plurality of holes 152, and the first hole 220 and the second hole 222 of the sixth plurality of holes 154 correspond to slots or adjacent surfaces defined in the first seat bracket 702 as optional fixation points between the adaptor plates 102A and 102B and the first seat bracket 702.

FIG. 7D provides an illustration of the fourth seat bracket 512 for attachment to the second adaptor plate configuration 600 of FIGS. 6A-6B. In FIG. 7D, the fourth seat bracket 512 corresponds to aftermarket and/or OEM seats of a fourth type. Examples of such fourth type of seat include, without limitation, BOSTROM branded PRO-RIDE type seats. FIG. 7D further highlights those of the holes 164-234 configured to receive mounting points of the fourth seat bracket 512 for securing the fourth seat bracket 512 and seat (not shown) to the second adaptor plate configuration 600. In this regard, each of the second hole 180 of the second plurality of holes 142, the first hole 210 and the second hole 212 of the fifth plurality of holes 152, the first hole 220 and the second hole 222 of the sixth plurality of holes 154, and the first hole 230 of the seventh plurality of holes 160 correspond to slots or adjacent surfaces defined in the first seat bracket 702 as optional fixation points between the adaptor plates 102A and 102B and the first seat bracket 702.

FIG. 7E provides an illustration of the fifth seat bracket 714 for attachment to the second adaptor plate configuration 600 of FIGS. 6A-6B. In FIG. 7E, the fifth seat bracket 714 corresponds to aftermarket and/or OEM seats of a fifth type. Examples of such fifth type of seat include, without limitation, BOSTROM branded WIDE-RIDE type seats. FIG. 5E further highlights those of the holes 164-234 configured to receive mounting points of the fifth seat bracket 714 for securing the fifth seat bracket 714 and seat (not shown) to the second adaptor plate configuration 600. In this regard, each of the third hole 174 of the first plurality of holes 140, the third hole 182 of the second plurality of holes 142, the first hole 210 and the second hole 212 of the fifth plurality of holes 152, and the first hole 220 and the second hole 222 of the sixth plurality of holes 154 correspond to slots or adjacent surfaces defined in the first seat bracket 702 as optional fixation points between the adaptor plates 102A and 102B and the first seat bracket 702.

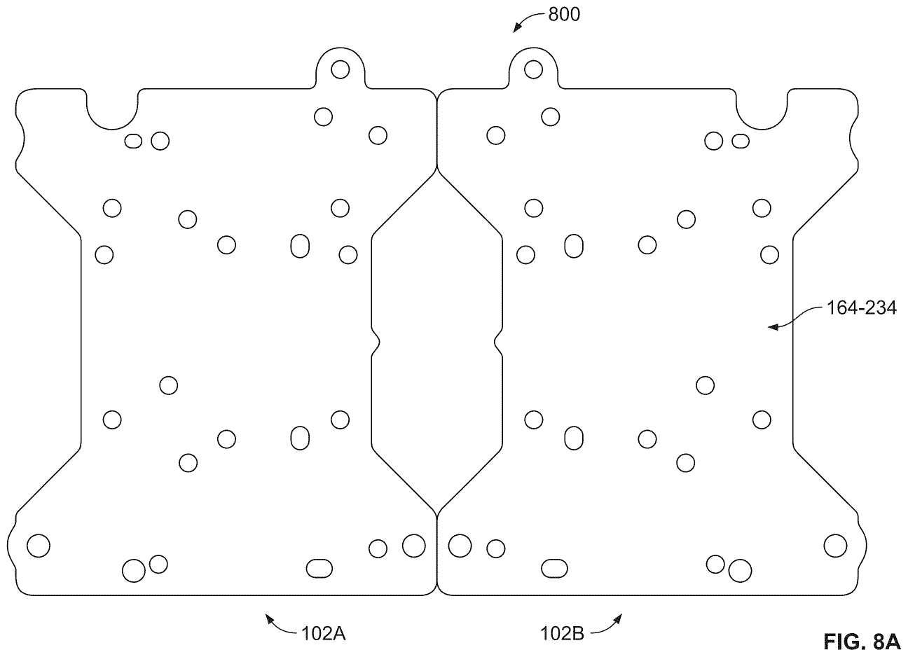

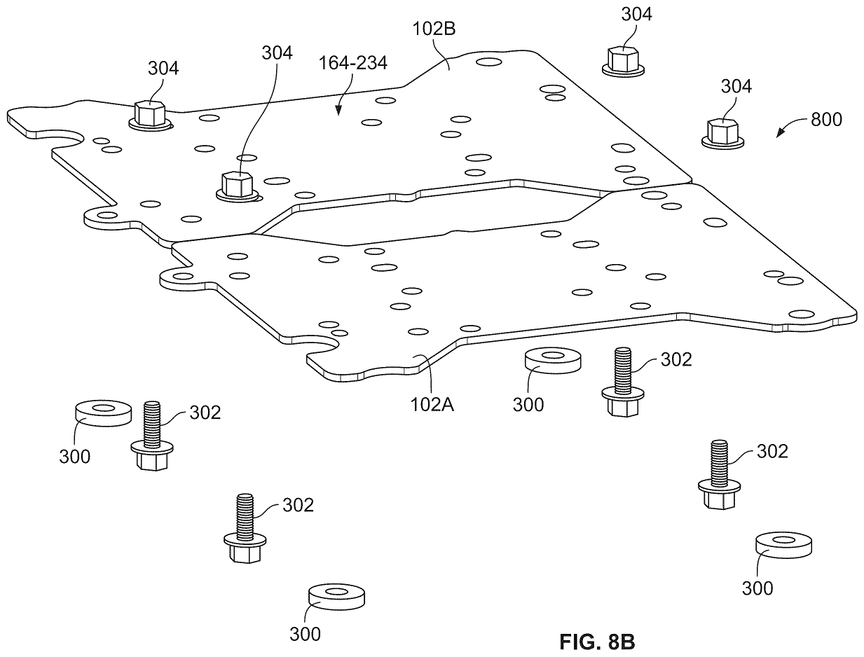

Referring now to FIGS. 8A and 8B, there are shown respective top and isometric views of a third configuration 800 of the adaptor plate system 100. As shown in FIGS. 8A-8B, two adaptor plates 102 are engaged on a substantially level plane. In the third configuration 800, the first adaptor plate 102A has been turned over, such that the bottom surface 324 is exposed. The first lateral side 104 of the first adaptor plate 102A is then positioned adjacent to the first lateral side 104 of the second adaptor plate 102B. As shown in FIGS. 8A and 8B, the first longitudinal sides 112 and the second longitudinal sides 114 of the first adaptor plate 102A and the second adaptor plate 102B remain positioned co-linear.

In this manner, the first adaptor plate 102A and the second adaptor plate 102B engage each other in the third configuration 800 such that the first lateral side 104 of the first adaptor plate 102A and the first lateral side 104 of the second adaptor plate 102B collectively define a second aperture 824 therebetween. The first lateral side 104 of the first adaptor plate 102A and the first lateral side 104 of the second adaptor plate 102B are engaged at opposite longitudinal positions along opposing sides of the second aperture 330, providing a stable and repeatable interface that preserves alignment of the adjoining adapter plates 102A, 102B. Further, the first adaptor plate 102A and the second adaptor plate 102B remain coplanar with each other in each of the first configuration 400, the second configuration 600, and the third configuration 800, ensuring that the adaptor plate system 100 presents a continuous and level mounting surface regardless of which tessellation arrangement is employed.

In the configuration 800 of FIGS. 8A-8B, the first longitudinal side 112 of the first adaptor plate 102A and the first longitudinal side 112 of the second adaptor plate 102B are positioned towards the front of the cab of the tractor unit, and the second longitudinal sides 114 of the first and second adaptor plates 102A-102B are positioned opposite thereof, towards the rear of the cab of the tractor unit. Attachment points of the third adaptor plate configuration 400 of FIGS. 8A-8B are highlighted, indicating the appropriate mounting points of the holes 164-234 to be used to secure the configuration 800 to the floor of the cab (not shown). It will be appreciated that the third configuration 800 of FIGS. 8A-8B corresponds to various models produced by, for example and without limitation, INTERNATIONAL, including, e.g., models in the PRO STAR, LONE STAR, LT families, and the like.

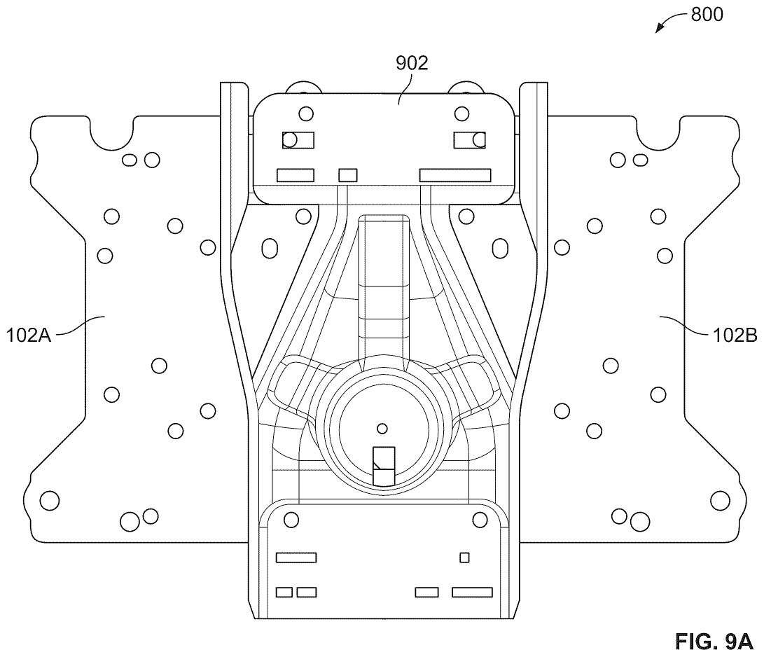

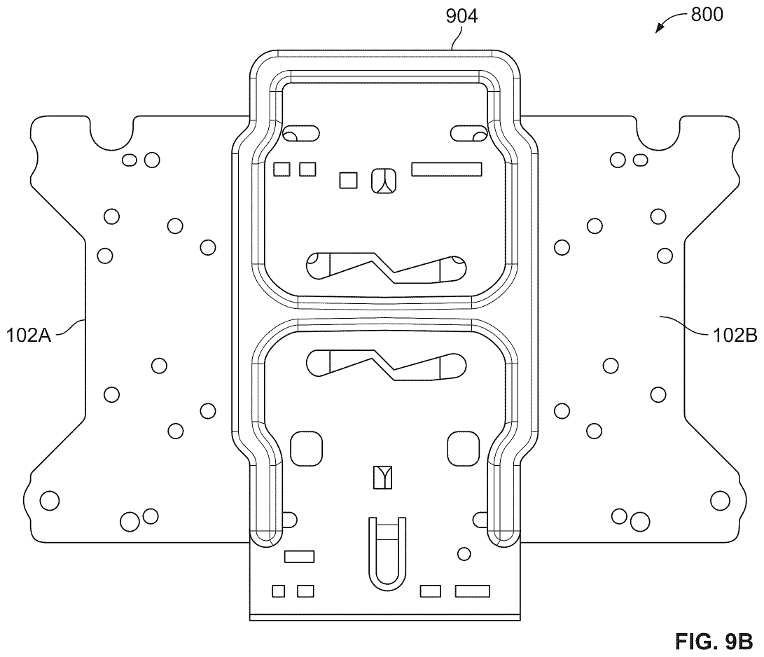

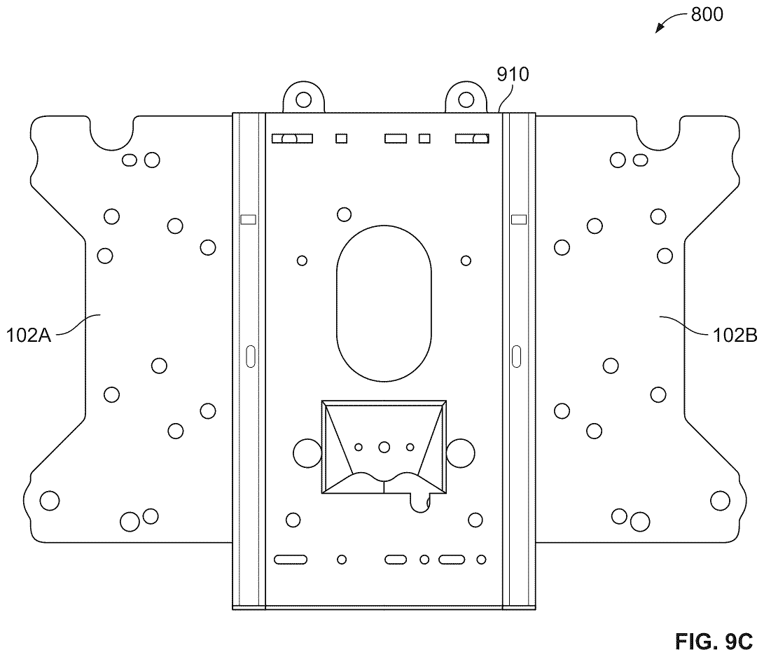

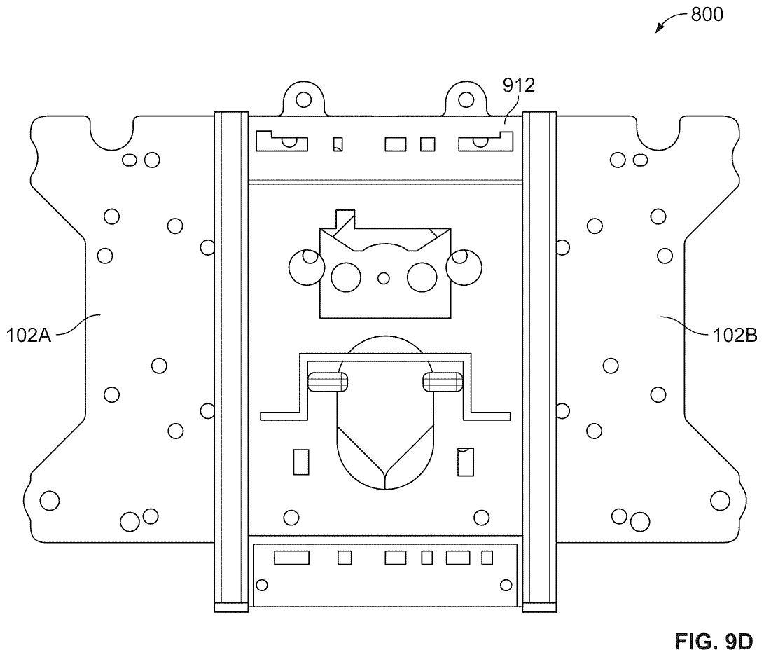

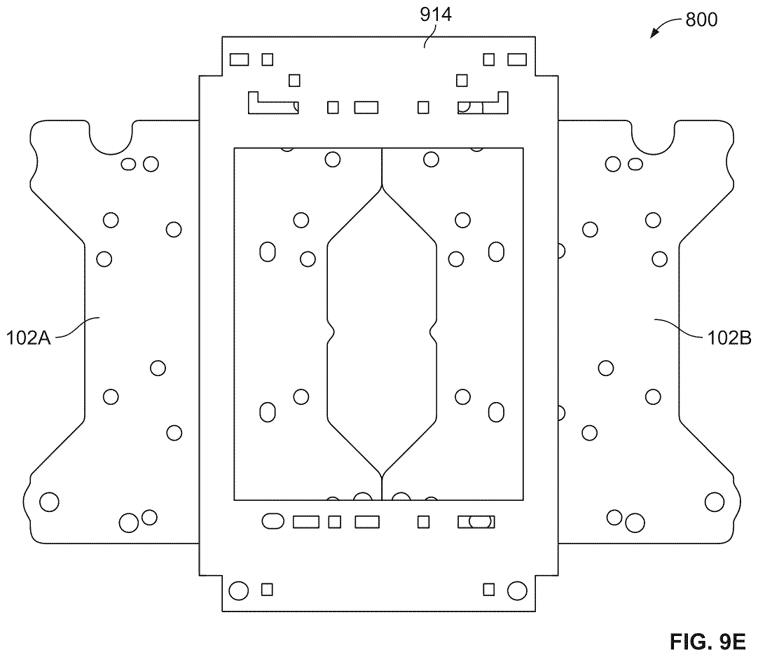

FIGS. 9A-9E provide illustrations of seat brackets 702-214 that may be secured to the third adaptor plate configuration 800 of FIGS. 8A-8B. Thus, FIG. 9A provides an illustration of the first seat bracket 902 for attachment to the third adaptor plate configuration 800 of FIGS. 8A-8B. In FIG. 9A, the first seat bracket 902 corresponds to aftermarket and/or OEM seats of a first type. Examples of such first type of seat include, without limitation, NATIONAL branded COMMODORE and ADMIRAL type seats. FIG. 9A further highlights those of the holes 164-234 configured to receive mounting points of the seat bracket 902 for securing the seat bracket 902 and seat (not shown) to the third adaptor plate configuration 800.

Referring now to FIG. 9B, there is shown an illustration of the second seat bracket 904 for attachment to the third adaptor plate configuration 800 of FIGS. 8A-8B. In FIG. 9B, the second seat bracket 904 corresponds to aftermarket and/or OEM seats of a second type. Examples of such second type of seat include, without limitation, NATIONAL branded ENSIGN, CAPTAIN, and CORSAIR type seats. FIG. 9B further highlights those of the holes 164-234 configured to receive mounting points of the second seat bracket 904 for securing the second seat bracket 904 and seat (not shown) to the third adaptor plate configuration 400.

FIG. 9C provides an illustration of the third seat bracket 910 for attachment to the third adaptor plate configuration 400 of FIGS. 8A-8B. In FIG. 9C, the third seat bracket 910 corresponds to aftermarket and/or OEM seats of a third type. Examples of such third type of seat include, without limitation, BOSTROM branded T-SERIES type seats. FIG. 9C further highlights those of the holes 164-234 configured to receive mounting points of the third seat bracket 910 for securing the third seat bracket 910 and seat (not shown) to the third adaptor plate configuration 800.

FIG. 9D provides an illustration of the fourth seat bracket 912 for attachment to the third adaptor plate configuration 800 of FIGS. 8A-8B. In FIG. 9D, the fourth seat bracket 912 corresponds to aftermarket and/or OEM seats of a fourth type. Examples of such fourth type of seat include, without limitation, BOSTROM branded PRO-RIDE type seats. FIG. 9D further highlights those of the holes 164-234 configured to receive mounting points of the fourth seat bracket 912 for securing the fourth seat bracket 912 and seat (not shown) to the third adaptor plate configuration 800.

FIG. 9E provides an illustration of the fifth seat bracket 914 for attachment to the third adaptor plate configuration 800 of FIGS. 8A-8B. In FIG. 9E, the fifth seat bracket 914 corresponds to aftermarket and/or OEM seats of a fifth type. Examples of such fifth type of seat include, without limitation, BOSTROM branded WIDE-RIDE type seats. FIG. 9E further highlights those of the holes 164-234 configured to receive mounting points of the fifth seat bracket 914 for securing the fifth seat bracket 914 and seat (not shown) to the third adaptor plate configuration 800.

It will be appreciated by the skilled artisan that the example configurations 400, 600, and 800 presented above with respect to FIGS. 4A-9E are intended solely as non-limiting example orientations of the universal adaptor plates 102A and 102B. Accordingly, variations on the orientations, positioning, and attachment of the universal adaptor plates 102A and 102B are contemplated and included herein.

Installation of the universal adaptor may include initially identifying the tractor unit or truck make (e.g., VOLVO, FREIGHTLINER, INTERNATIONAL, PETERBILT, KENWORT, etc.). After identification of the truck, the particular seat brand and type is identified. Thereafter, the corresponding installation diagram is identified. It will be appreciated that the adaptor plates 102A-102B are installed onto seat 202-210 first. Accordingly, the proper mounting holes are located in the seat base 202-210. With the seat lying on its back, the adaptor plates 102A-102B are arranged in the correct orientation and threaded fasteners 106 (e.g., bolts) are extended through the corresponding holes from the bottom up. Thereafter, each fastener is torqued to 20 lbs ft. +/−2 (27 Nm +/−3). The spacers 104 are then positioned in-between the adaptor plates 102A-102B and floor mounting holes. Thereafter, fasteners coupling the adaptor plates 102A-102B to the cab floor are torqued and tether lengths adjusted to factory specifications.

In certain embodiments, a method of manufacturing a universal plate system is provided. The method includes forming an adapter plate 102 having a first lateral side 104 and a second lateral side 110 opposite the first lateral side 104 in a lateral direction, and further having a first longitudinal side 112 and a second longitudinal side 114 opposite the first longitudinal side 112 in a longitudinal direction orthogonal to the lateral direction. A tab 124 is formed integrally with or fixed to the adapter plate 102 along the first longitudinal side 112, and a recess 130 is defined in the adapter plate 102 along the first longitudinal side 112. The tab 124 is offset from the first lateral side 104 by a first lateral distance, and the recess 130 is offset from the second lateral side 110 by a second lateral distance, where the first lateral distance and the second lateral distance are equal so that the tab 124 and recess 130 are laterally complementary. The method further includes forming a tang 132 fixed with the adapter plate 102 along the second longitudinal side 114, and defining an indent 134 in the adapter plate 102 along the second longitudinal side 114. The tang 132 is offset from the first longitudinal side 112 by a first longitudinal distance, and the indent 134 is offset from the second longitudinal side 114 by a second longitudinal distance, where the first longitudinal distance and the second longitudinal distance are equal so that the tang 132 and indent 134 are longitudinally complementary.

In certain embodiments, the method further includes forming a first plurality of holes 140 that includes a first hole 164, a second hole 170, and a third hole 172. The first hole 164 is defined in the tab 124 and extends beyond the first longitudinal side 112 in the longitudinal direction. The second hole 170 is defined in the adapter plate 102 such that the second hole 170 overlaps or is located inward of the first hole 164 in the lateral direction, and is positioned closer to the second longitudinal side 114 as compared to the first longitudinal side 112. The third hole 172 is defined in the adapter plate 102 and is aligned with the second hole 170 in the longitudinal direction, while being located closer to the first longitudinal side 112 as compared to the second longitudinal side 114. The method also includes forming a second plurality of holes 142 that includes a first hole 174, a second hole 180, a third hole 182, and a fourth hole 184. The first hole 174 and second hole 180 are located closer to the first longitudinal end portion 240 as compared to the second longitudinal end portion 242, whereas the third hole 182 and fourth hole 184 are located closer to the second longitudinal end portion 242 as compared to the first longitudinal end portion 240. The first hole 174 and the third hole 182 are located closer to the first lateral side 104 as compared to the second lateral side 110, while the second hole 180 and the fourth hole 184 are located closer to the second lateral side 110 as compared to the first lateral side 104. The first hole 174 and the second hole 180 are aligned in the lateral direction, the third hole 182 and the fourth hole 184 are aligned in the lateral direction, the first hole 174 and the third hole 182 are aligned in the longitudinal direction, and the second hole 180 and the fourth hole 184 are aligned in the longitudinal direction. In addition, the method includes forming a third plurality of holes 144 that includes a first hole 190 and a second hole 192. The first hole 190 is located closer to the first longitudinal end portion 240 as compared to the second longitudinal end portion 242, and the second hole 192 is located closer to the second longitudinal end portion 242 as compared to the first longitudinal end portion 240. Both the first hole 190 and the second hole 192 are positioned beyond an edge of the first lateral side 104 at the longitudinal middle portion 244 in the lateral direction. In other embodiments, the method may include forming a fourth plurality of holes 150 that includes a first hole 202 and a second hole 204. The first hole 202 and the second hole 204 are offset from the second plurality of holes 142 in the longitudinal direction, are located closer to the first longitudinal end portion 240 as compared to the second longitudinal end portion 242, and are configured such that the first hole 202 overlaps the first hole 174 and the third hole 182 of the second plurality of holes 142, and the second hole 204 overlaps the second hole 180 and the fourth hole 184 of the second plurality of holes 142.

In additional embodiments, the method includes forming a fifth plurality of holes 152 that includes a first hole 210 and a second hole 212. The first hole 210 and the second hole 212 are aligned in the longitudinal direction and positioned on the longitudinal middle line 250 of the adapter plate 102, offset from one another in the longitudinal direction. The method further includes forming a sixth plurality of holes 154 that includes a first hole 216 and a second hole 218. The first hole 216 and the second hole 218 are aligned in the longitudinal direction, offset from the fifth plurality of holes 152 in the lateral direction, located closer to the first lateral side 104 as compared to the second lateral side 110, and offset from one another in the longitudinal direction. The method also includes forming a seventh plurality of holes 160 that includes a first hole 220 and a second hole 222. The first hole 220 and the second hole 222 are aligned in the longitudinal direction, offset from the fifth plurality of holes 152 in the lateral direction, and located closer to the second lateral side 110 as compared to the first lateral side 104. The first hole 220 and the second hole 222 are further located outward of the second plurality of holes 142 in the longitudinal direction, and offset from one another in the longitudinal direction. In some embodiments, the method includes forming an eighth plurality of holes 162 that includes a first hole 230 and a second hole 232. The first hole 230 and the second hole 232 overlap in the longitudinal direction, are offset from the fifth plurality of holes 152 in the lateral direction farther than the seventh plurality of holes 160, are located closer to the second lateral side 110 as compared to the first lateral side 104, and are further located outward of the seventh plurality of holes 160 in both the lateral direction and the longitudinal direction.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. A universal adaptor plate system, comprising:
an adapter plate having a first lateral side, a second lateral side opposite the first lateral side in a lateral direction, a first longitudinal side, and a second longitudinal side opposite the first longitudinal side in a longitudinal direction orthogonal to the lateral direction;
a tab extended from the adapter plate at a location along the first longitudinal side, wherein the adapter plate defines a recess at a location along the first longitudinal side, and the tab is offset from the first lateral side a same distance the recess is offset from the second lateral side in the lateral direction; and
a tang extended from the adapter plate at a location along the second lateral side, wherein the adapter plate defines an indent at a location along the second lateral side, and the tang is offset from the first longitudinal side a same distance the indent is offset from the second longitudinal side.

2. The system of claim 1, wherein the tab and the adapter plate define a first plurality of holes, including a first hole in the tab and a second hole in the adapter plate, the first hole is located beyond the first longitudinal side in the longitudinal direction, the second hole overlaps or is located inward of the first hole in the lateral direction, and the second hole is located closer to the second longitudinal side as compared to the first longitudinal side in the longitudinal direction.

3. The system of claim 2, wherein the first plurality of holes includes a third hole defined in the adapter plate, where the third hole is aligned with the second hole in the longitudinal direction, and located closer to the first longitudinal side as compared to the second longitudinal side.

4. The system of claim 1, wherein the adapter plate defines a second plurality of holes, including a first hole and a second hole located closer to the first longitudinal side as compared to the second longitudinal side, and including a third hole and a fourth hole located closer to the second longitudinal side as compared to the first longitudinal side, and
the first hole and the third hole are located closer to the first lateral side as compared to the second lateral side, and the second hole and the fourth hole are located closer to the second lateral side as compared to the first lateral side.

5. The system of claim 4, wherein the first hole and the second hole are offset from the first longitudinal side in the longitudinal direction, and the third hole and the fourth hole are offset from the second longitudinal side a same distance as the first hole and the second hole from the first longitudinal side, and
the first hole and the third hole are offset from the first lateral side, and the second hole and the fourth hole are offset from the second lateral side a same distance as the first hole and the third hole from the first lateral side.

6. The system of claim 4, wherein the adapter plate includes a first longitudinal end portion, a second longitudinal end portion, and a middle longitudinal portion that is narrower than the first longitudinal end portion and the second longitudinal end portion in the lateral direction,
the middle longitudinal portion is interposed between and separates the first longitudinal portion and the second longitudinal portion, and extends across a middle line of the adapter plate in the longitudinal direction, and
the adapter plate defines the second plurality of holes in the middle longitudinal portion.

7. The system of claim 6, wherein the first longitudinal end portion and the second longitudinal end portion define a third plurality of holes aligned in the longitudinal direction, including a first hole in the first longitudinal end portion, and a second hole in the second longitudinal end portion, wherein the third plurality of holes are each located closer to the first lateral side as compared to the second lateral side, and are each located beyond the first lateral side at the middle longitudinal portion in the lateral direction.

8. The system of claim 7, wherein the third plurality of holes includes a third hole and a fourth hole defined in the second longitudinal end portion, aligned with each other in the lateral direction, and overlapping the second hole of the third plurality of holes in the lateral direction, the third hole in the third plurality of holes being located closer to the first lateral side as compared to the second lateral side, and the fourth hole in the third plurality of holes being located closer to the second lateral side as compared to the first lateral side.

9. The system of claim 4, wherein the adapter plate defines a fourth plurality of holes that are each offset from the second plurality of holes in the longitudinal direction, located closer to the first longitudinal side as compared to the second longitudinal side.

10. The system of claim 9, wherein the fourth plurality of holes includes a first hole that overlaps the first hole and the third hole in the second plurality of holes, and
the fourth plurality of holes includes a second hole that overlaps the second hole and the fourth hole in the second plurality of holes.

11. The system of claim 1, wherein the adapter plate defines a fifth plurality of holes aligned in the longitudinal direction, on a longitudinal middle line of the adapter plate, and the adapter plate defines a sixth plurality of holes aligned in the longitudinal direction, offset from the fifth plurality of holes in the lateral direction, and located closer to the first lateral side as compared to the second lateral side in the lateral direction.

12. The system of claim 11, wherein the adapter plate defines a seventh plurality of holes aligned in the longitudinal direction, offset from the fifth plurality of holes in the lateral direction, located closer to the second lateral side as compared to the first lateral side, and located outward of the second plurality of holes in the longitudinal direction.

13. The system of claim 12, wherein the adapter plate defines an eighth plurality of holes aligned in the longitudinal direction, offset from the fifth plurality of holes in the lateral direction, farther than the seventh plurality of holes, located closer to the second lateral side as compared to the first lateral side, and located outward of the seventh plurality of holes in the longitudinal direction.

14. The system of claim 13, wherein the eighth plurality of holes includes four holes located outward of the seventh plurality of holes in the lateral direction and the longitudinal direction.

15. The system of claim 13, wherein the fifth plurality of holes, the sixth plurality of holes, the seventh plurality of holes, or the eighth plurality of holes are respectively symmetric in the longitudinal direction, and centered on a lateral middle line of the adapter plate.

16. The system of claim 11, wherein the plate defines the fifth plurality of holes including a third hole located between the first hole and the second hole in the longitudinal direction, and located closer to the second lateral side as compared to the first lateral side in the lateral direction.

17. The system of claim 1, wherein the adapter plate is planar in a normal direction perpendicular to the longitudinal direction and the lateral direction, the adapter plate is a first adapter plate, the tab is a first tab, the recess is a second recess, the tang is a first tang, the indent is a first indent, and the system further comprises:
a second adapter plate having a first lateral side, a second lateral side opposite the first lateral side in the lateral direction, a first longitudinal side, and a second longitudinal side opposite the first longitudinal side in the longitudinal direction;
a second tab extended from the second adapter plate at a location along the first longitudinal side of the second adapter plate, wherein the second adapter plate defines a second recess at a location along the first longitudinal side of the second adapter plate, and the second tab is offset from the first lateral side a same distance the recess is offset from the second lateral side of the second adapter plate in the lateral direction; and
a second tang extended from the adapter plate at a location along the second lateral side of the second adapter plate, wherein the second adapter plate defines a second indent at a location along the second lateral side of the second adapter plate, and the second tang is offset from the first longitudinal side a same distance the indent is offset from the second longitudinal side of the second adapter plate in the longitudinal direction,
wherein the first adapter plate and the second adapter plate engage each other in a first configuration where first tab engages the second recess, and the second tab engages the first recess,
the first adapter plate and the second adapter plate engage each other in a second configuration where the second lateral side of the first adapter plate and the second lateral side of the second adapter plate define a first aperture, the first tang engages the second indent, and the second tang engages the first indent at a side of the first aperture opposite the first tab in the longitudinal direction, or
the first adapter plate and the second adapter plate engage each other in a third configuration where the first lateral side of the first adapter plate and the first lateral side of the second adapter plate define a second aperture, and the first lateral side of the first adapter plate engages the first lateral side of the second adapter plate at opposite sides of the second aperture in the longitudinal direction, and
the first adapter plate and the second adapter plate are coplanar with each other in the first configuration, the second configuration, or the third configuration.

18. A method of manufacturing a universal plate system, the method comprising:
forming an adapter plate having a first lateral side, a second lateral side opposite the first lateral side in a lateral direction, a first longitudinal side, and a second longitudinal side opposite the first longitudinal side in a longitudinal direction orthogonal to the lateral direction;
forming a tab fixed with the adapter plate along the first longitudinal side,
defining a recess in the adapter plate along the first longitudinal side, wherein the tab is offset from the first lateral side a same distance that the recess is offset from the second lateral side in the lateral direction;
forming a tang fixed with the adapter plate along the second lateral side;
defining an indent in the adapter plate along the second lateral side; and
positioning the tang offset from the first longitudinal side a same distance that the indent is offset from the second longitudinal side in the longitudinal direction.

19. The method of claim 18, further comprising:
forming a first plurality of holes including a first hole, a second hole, and a third hole, wherein the first hole is defined in the tab and located beyond the first longitudinal side in the longitudinal direction, the second hole is defined in the adapter plate, the second hole overlaps or is located inward of the first hole in the lateral direction, the second hole is located closer to the second longitudinal side as compared to the first longitudinal side in the longitudinal direction, the third hole is defined in the adapter plate, the third hole is aligned with the second hole in the longitudinal direction, and the third hole is located closer to the first longitudinal side as compared to the second longitudinal side;
forming a second plurality of holes including a first hole, a second hole, a third hole, and a fourth hole, wherein the first hole and the second hole are located closer to the first longitudinal end as compared to the second longitudinal end, and the third hole and the fourth hole are located closer to the second longitudinal end as compared to the first longitudinal end, the first hole and the third hole are located closer to the first lateral side as compared to the second lateral side, the second hole and the fourth hole are located closer to the second lateral side as compared to the first lateral side, the first hole and the second hole are aligned in the lateral direction, the third hole and the fourth hole are aligned in the lateral direction, the first hole and the third hole are aligned in the longitudinal direction, and the second hole and the fourth hole are aligned in the longitudinal direction;
forming a third plurality of holes including a first hole and a second hole, wherein the first hole is located closer to the first longitudinal end as compared to the second longitudinal end, the second hole is located closer to the second longitudinal end as compared to the first longitudinal end, and the first hole and the second hole are each located beyond an edge of the first lateral side at a middle longitudinal portion in the lateral direction; or
forming a fourth plurality of holes including a first hole and a second hole, wherein the first hole and the second hole are offset from the second plurality of holes in the longitudinal direction, the first hole and the second hole are located closer to the first longitudinal end as compared to the second longitudinal end, the first hole overlaps the first hole and the third hole of the second plurality of holes, and the second hole overlaps the second hole and the fourth hole of the second plurality of holes.

20. The method of claim 18, further comprising:
forming a fifth plurality of holes including a first hole and a second hole, wherein the first hole and the second hole are aligned in the longitudinal direction, the first hole and the second hole are located on a longitudinal middle line of the adapter plate, and the first hole and the second hole are offset from each other in the longitudinal direction;
forming a sixth plurality of holes including a first hole and a second hole, wherein the first hole and the second hole are aligned in the longitudinal direction, the first hole and the second hole are offset from the fifth plurality of holes in the lateral direction, the first hole and the second hole are located closer to the first lateral side as compared to the second lateral side, and the first hole and the second hole are offset from each other in the longitudinal direction;
forming a seventh plurality of holes including a first hole and a second hole, wherein the first hole and the second hole are aligned in the longitudinal direction, the first hole and the second hole are offset from the fifth plurality of holes in the lateral direction, the first hole and the second hole are located closer to the second lateral side as compared to the first lateral side, and the first hole and the second hole are offset from each other in the longitudinal direction; and
forming an eighth plurality of holes including a first hole and a second hole that overlap in the longitudinal direction, are offset from the fifth plurality of holes in the lateral direction farther than the seventh plurality of holes, are located closer to the second lateral side as compared to the first lateral side, are located outward of the seventh plurality of holes in the lateral direction and the longitudinal direction.
